(19) United States
(12) Patent Application Publication
(10) Pub. No.: US 2026/0246712 A1
(43) Pub. Date: Aug. 20, 2026

(54) System and method to dynamically reprovision artificial intelligence-controlled servers via decentralized networks

(71) Applicant: Bank of America Corporation, Charlotte, NC (US)

(72) Inventors: Debraj Goswami, Hyderabad (IN); Kathiravan Mohamed Ali, Chennai (IN); Deepak Suresh Dhokane, Mumbai (IN)

(21) Appl. No.: 19/058,665

(22) Filed: Feb. 20, 2025

(51) Int. Cl. H04L 41/16; H04L 41/0806

(52) U.S. Cl. CPC H04L 41/16; H04L 41/0806

(57) ABSTRACT

A system comprises a memory communicatively coupled to at least one processor. The at least one processor is configured to provision multiple servers in the network in accordance with multiple provisioning parameters, and train artificial intelligence algorithms based on input data representative of historical data associated with previous performance of the servers, expected performance of the servers, and expected usage availability in the servers. Further, the at least one processor may be configured to, using the trained artificial intelligence algorithms, create tracking parameters configured to track performances of servers, track the performances of the servers, electronically assign the performance of the servers to a real expected usages in the servers, determine whether the real expected usages of the servers are above an expected usage threshold, and tag the server as a recipient server or a donor server in response to the determination.

### TECHNICAL FIELD

The present disclosure relates generally to operations associated with reprovisioning servers in data centers, and more specifically to a system and method to dynamically reprovision artificial intelligence-controlled servers via decentralized networks.

### BACKGROUND

A data center is a physical facility configured to store Information Technology (IT) operations and equipment, such as servers, storage systems, networking hardware, and other infrastructure. Several inefficiencies are associated with conventional data centers in relation to controlling, managing, and distributing resources in a data center. Additional inefficiencies exist in relation to optimizing resource consumption in a data center. In conventional data centers, large amounts of traffic in data center operations may cause data centers to slow down and/or stop operations over significant periods of time. In particular, heavy traffic loads (e.g., at, or approaching, a traffic capability) in a data center may cause the data center to drop communications deemed to be of lesser importance causing missed communications and/or incomplete data exchanges in a network.

### SUMMARY OF THE DISCLOSURE

In one or more embodiments, a system and method described herein are configured to dynamically reprovision artificial intelligence-controlled servers via decentralized networks. In particular, the system may be configured to train an artificial intelligence algorithm to generate an artificial intelligence model configured to dynamically change provisioning of network resources assigned in each server in a network. In some embodiments, the system may be configured to determine and generate provisioning parameters based on the predicted resource demands and/or consumption, provision a data center based on the provisioning parameters, and deploy provisioned versions of the data center. The data centers maybe one or more physical facilities that store application information (e.g., service configurations) and data associated with one or more operations performed in the network. The data center may be a location where computing and networking equipment is used to collect, process, and store data, as well as to distribute and enable access to processing resources, memory resources, and/or power resources. The system may be configured to provision server resources. In some embodiments, the actions and/or operations of the data center may be evaluated, diagnosed, controlled, and/or managed by the system upon execution of one or more artificial intelligence algorithms to generate one or more artificial intelligence models. The artificial intelligence models may be supervised artificial intelligence models and/or unsupervised artificial intelligence models, among others. The supervised artificial intelligence models may be artificial intelligence models trained to understand and/or predict operations associated with a specific user profile in the communication network. The unsupervised artificial intelligence models may be artificial intelligence models trained to understand and/or predict operations associated with general behavior of entities interacting with the communication network. The artificial intelligence models may be implemented in accordance with one or more guidelines, to perform network analyses using one or more neural networks, and/or one or more large language models (LLMs). The neural networks may be a computing system comprising a network of interconnected nodes, called artificial neurons, to process data in a decentralized manner. The LLMs may be artificial intelligence models that use machine learning to process and generate human language.

In some embodiments, the system is configured to balance traffic across multiple servers in the network and keep track of performance in the servers using electronic credits. The electronic credits may be exchanged in the network using a decentralized network. The electronic credits may be gained by a given server by processing traffic loads from other servers, initially connecting to the network, and/or after spending one or more predefined amounts of time connected to the network. The electronic credits may be lost by a given server by requesting help from other servers to process traffic loads and/or after disconnecting from the network. Over time, a system administrator may be configured to collect electronic credit information for each of the servers in the network. The electronic credit information may be used to determine under provisioning of a given server comprising a credit deficit representing that the given server is constantly overloaded and asking other servers to handle its traffic. Further, the electronic credit information may be used to determine overprovisioning of a given server comprising an excessive credit surplus representing that the given server is constantly underloaded and offering to handle traffic for other servers.

In one or more embodiments, the systems are directed to improvements in computer systems. Specifically, the systems reduce processor and memory usage in data centers and/or servers in the data centers by reducing and/or inhibiting over provisioning and/or under provisioning of servers. Herein, processing and memory usage is reduced because processing and memory resources are not wasted in new data centers. Instead, the system provisions new data centers to include a specific number of resources that are expected to be used at higher levels of efficiency. Further, the systems are configured to prevent resources from being wasted by data centers and/or individual servers in data centers by provisioning resources in new servers to meet and/or match specific efficiency levels. Herein, meeting and/or matching specific efficiency levels may correspond to using resources in new servers to meet one or more specific target operational performances.

For example, performance anomalies such as CPU overutilization, memory leaks, or disk I/O bottlenecks may slow down processing and negatively impact an entire data center. The negative impacts may include performance anomalies, such as: 1) dropping application operations that rely on servers hosting and/or server usage; 2) compromising data sets and/or databases stored in specific data centers because servers are unresponsive and/or offline; and 3) creation of cybersecurity vulnerabilities due to overburdened servers (e.g., Distributed Denial-of-Service (DDoS) attacks). To the extent that these performance anomalies are caused by underutilization of resources and/or over utilization of resources (e.g., inefficient usage of resources), the system may be configured to predict and/or proactively address the performance anomalies before anomalies occur. In this regard, the system improves processing performance in a data center by avoiding anomalies such as CPU overutilization, memory leaks, or disk I/O bottlenecks. Another technical advantage resulting from predicting and avoiding performance anomalies includes inhibiting, reducing, and/or eliminating network congestions. Performance anomalies like network congestion or bandwidth saturation can lead to increased latency in the data center, slowing down data transfer speeds and application responsiveness. By predicting and/or proactively avoiding these anomalies from occurring, the new data centers may be configured to improve network traffic flows more smoothly, ensuring low-latency performance for applications, and services hosted in the data center.

In one or more embodiments, unlike conventional data centers and/or servers, the system and method detect and/or proactively resolve performance bottlenecks promptly and effectively. Detecting performance bottlenecks occurring in a data center promptly and accurately and further promptly resolving detected performance bottlenecks provides several technical advantages. Resolving a performance bottleneck in a data center directly improves the performance of the data center in several ways. For example, resolving a performance bottleneck may result in improved data center efficiency. By addressing bottlenecks, the system may manage more requests and complete tasks more quickly. Herein, the system may be configured to increase processing data speeds, quicker application response times, and overall higher throughput. An additional technical advantage of promptly detecting and resolving performance bottlenecks may include improved resource utilization. For example, when bottlenecks are resolved, the use of data center resources like CPUs, memory, storage, and network bandwidth may be improved. These improvements may lead to more faster analyses, operations, and/or prevents certain resources from becoming overworked while resources are utilized. Another technical advantage of promptly detecting and resolving performance bottlenecks may include reduced system latency. Bottlenecks often cause delays in data transfer or processing, leading to slower response times for applications and services. By resolving bottlenecks, latency is reduced, and the performance of critical applications improves, which is especially important for time-sensitive tasks.

In one or more embodiments, the systems may comprise an apparatus, such as the server. Further, the system may be a data exchange system, which comprises the apparatus. In addition, the system may be configured to perform operations as part of a process performed by the apparatus. As a non-limiting example, the apparatus may comprise a memory and a processor communicatively coupled to one another. The memory may be operable to store at least one artificial intelligence algorithm configured to evaluate data. The processor may be configured to provision a first server in a network in accordance with multiple provisioning parameters, provision a second server in the network in accordance with the provisioning parameters, and train an artificial intelligence algorithm based at least in part upon input data representative of historical data associated with previous performance of the first server and the second server, expected performance of the first server and the second server, and expected usage availability in the first server and the second server.

Further, the processor may be configured to, using the trained artificial intelligence algorithm, create first tracking parameters configured to track a first performance of the first server, track, in conjunction with the first tracking parameters, the first performance of the first server, electronically assign the first performance of the first server to a first real expected usage in the first server, determine whether the first real expected usage of the first server is above the expected usage threshold, and tag the first server as a recipient server in response to determining that the first real expected usage of the first server is above the expected usage threshold. Further, the processor is configured to, using the trained artificial intelligence algorithm, calculate a recipient difference between the first real expected usage of the first server and the expected usage threshold, create second tracking parameters configured to track a second performance of the second server, track, in conjunction with the second tracking parameters, the second performance of the second server, electronically assign the second performance of the second server to a second real expected usage in the second server, determine whether the second real expected usage of the second server is below the expected usage threshold, and tag the second server as a donor server in response to determining that the second real expected usage of the second server is below the expected usage threshold.

In addition, the processor is configured to, using the trained artificial intelligence algorithm, calculate a donor difference between the second real expected usage of the second server and the expected usage threshold, compare the recipient difference to the donor difference, reprovision the first server in the network in accordance with the provisioning parameters to handle the first real expected usage of the first server minus the recipient difference in response to the recipient difference being greater than the donor difference, and reprovision the second server in the network in accordance with the provisioning parameters to handle the second real expected usage of the second server plus the recipient difference in response to the recipient difference being less than the donor difference.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a system in accordance with one or more embodiments;

FIG. 2 illustrates an operational flow configured to evaluate, modify, and/or control server resources performed by the system of FIG. 1 in accordance with one or more embodiments; and

FIGS. 3A-3C illustrate an example flowchart of a method to provision servers following the operational flow of FIG. 2 in accordance with one or more embodiments.

### DETAILED DESCRIPTION

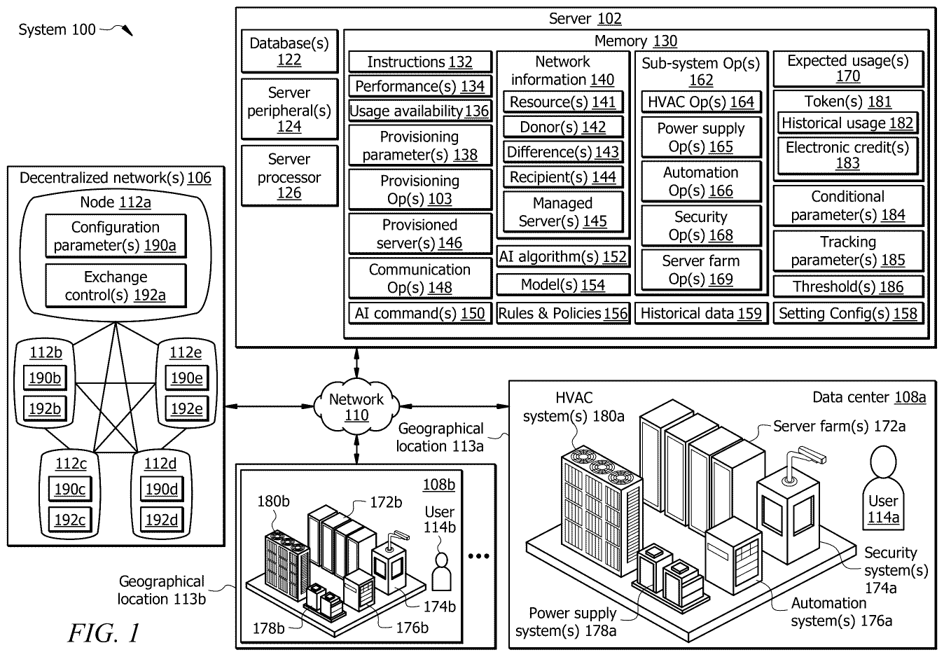

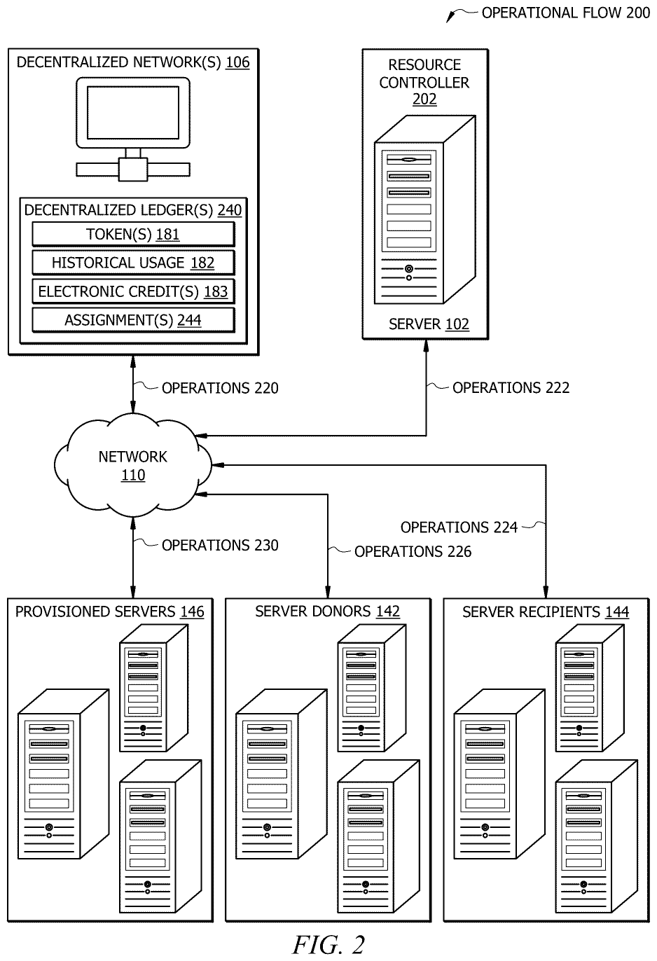

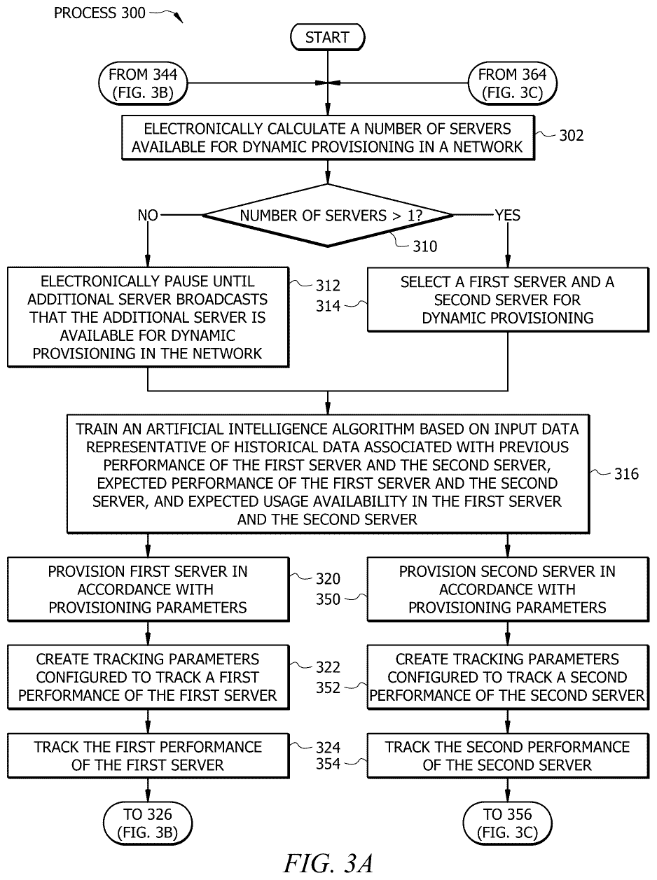

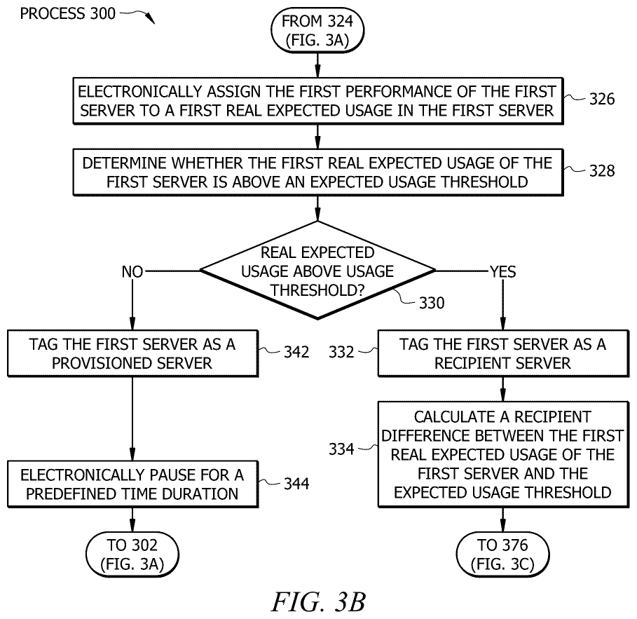

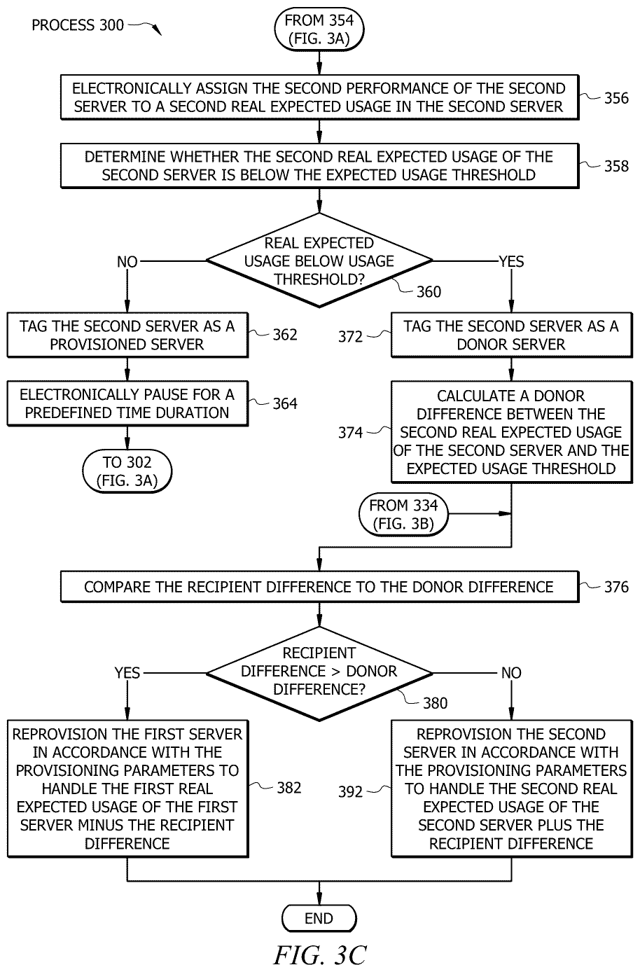

As described above, this disclosure provides various systems and methods to dynamically reprovision artificial intelligence-controlled servers via decentralized networks. FIG. 1 illustrates a system 100 in which a server 102 is configured to provision and/or deploy additional servers in data centers 108 in a communication network. FIG. 2 illustrates an operational flow 200 performed by the system 100 of FIG. 1. FIGS. 3A-3C illustrate a process 300 performed by the system 100 of FIG. 1.

### System Overview

FIG. 1 illustrates an example system 100, in accordance with one or more embodiments. The system 100 may comprise a server 102 configured to perform one or more provisioning operations 103, one or more modification operations, and/or one or more orchestration operations. The system 100 includes a server 102 communicatively coupled to a data center 108a and a data center 108b (collectively, data centers 108) and/or a node 112a, a node 112b, a node 112c, a node 112d, and a node 112e (collectively, nodes 112) in the one or more decentralized networks 106 via a network 110. The data centers 108 may be user nodes configured to trigger exchanges of data and/or perform one or more data center operations with each other and/or with the server 102 via the network 110. The data centers 108 may be working nodes configured to receive instructions to perform one or more data center operations based on instructions received from the server 102. The data centers 108 maybe one or more physical facilities that store application information (e.g., service configurations) and data associated with one or more operations performed in a communication network. The data center 108 may be a location where computing and networking equipment I s used to collect, process, and store data, as well as to distribute and enable access to processing resources, memory resources, and/or power resources. In some embodiments, some of the data centers 108 may be clustered together in one or more geographical locations 113 (e.g., shown as a geographical location 113a and a geographical location 113b). Each of the data centers 108 may be associated with one or more corresponding operators. These operators are shown as a user 114a and a user 114b (collectively, users 114) in the geographical locations 113. In FIG. 1, the geographical location 113a is shown comprising the user 114a associated with the data center 108a. The geographical location 113b is shown comprising the user 114b associated with the data center 108b and additional data centers 108.

In one or more embodiments, the server 102 may comprise one or more databases 122, one or more server peripherals 124, one or more server processors 126, and at least one memory 130 communicatively coupled to one another. In some embodiments, the memory 130 may comprise instructions 132, one or more performances 134, at least one usage availability 136, the one or more provisioning operations 103, one or more provisioning parameters 138, network information 140 comprising server resources 141, one or more server donors 142, one or more differences 143, one or more server recipients 144, and a number of managed servers 145, one or more provisioned servers 146, one or more communication operations 148, one or more artificial intelligence (AI) commands 150, one or more AI algorithms 152 configured to train and/or perform one or more operations in accordance with one or more models 154, one or more rules and policies 156, one or more setting configurations 158 associated with management and/or control of one or more resources 141 in one or more of the data centers 108, historical data 159 associated with the one or more managed servers 145, one or more sub-system operations 162 comprising heating, ventilation, and air conditioning (HVAC) operations 164, one or more power supply operations 165, one or more automation operations 166, one or more security operations 168, and one or more server farm operations 169, one or more expected usages 170, one or more tokens 181 comprising representation of historical usage 182 and one or more electronic credits 183 for one or more managed servers 145, one or more conditional parameters 184 associated with one or more the differences 143, one or more tracking parameters 185 and one or more one or more thresholds 186 (e.g., tolerances).

Referring to the data center 108a a non-limiting example, the data center 108a may comprise one or more sub-systems comprising one or more server farms 172a, one or more security systems 174a, one or more automation systems 176a, one or more power supply systems 178a, one or more HVAC systems 180a communicatively coupled to one another.

### System Components

### Server

The server 102 is generally any device or apparatus that is configured to process data and communicate with computing devices (e.g., the data centers 108), additional databases, systems, and the like, via the one or more server peripherals 124 (i.e., a user interface or a network interface). The server 102 may comprise the server processor 126 that is generally configured to oversee operations of the processing engine. The operations of the processing engine are described further below in conjunction with the system 100 described in FIG. 1, the operational flow 200 described in FIG. 2, and the process 300 described in FIGS. 3A-3C.

The server 102 comprises multiple databases 122 configured to provide one or more memory resources to the server 102 and the data centers 108. The server 102 comprises the server processor 126 communicatively coupled with the databases 122, the server peripherals 124, and the memory 130. The server 102 may be configured as shown, or in any other configuration. In one or more embodiments, the databases 122 are configured to store data that enables the server 102 to configure, manage and coordinate one or more middleware systems. In some embodiments, the databases 122 store data used by the server 102 to function as a halfway point in between services 161 and other tools or databases.

In one or more embodiments, the server peripherals 124 may be configured to enable wired and/or wireless communications. The server peripherals 124 may be configured to communicate data between the server 102 and data centers 108 (i.e., user devices, routers, and/or managed servers 145 in the network 110), systems, or domain(s) via the network 110. For example, the server peripherals 124 may comprise a WI-FI interface, a LAN interface, a WAN interface, a modem, a switch, or a router. The server processor 126 may be configured to send and receive data using the server peripherals 124. The server peripherals 124 may be configured to use any suitable type of communication protocol. In some embodiments, the server peripherals 124 may be an admin console comprising a display configured to show a user interface used to manage a middleware server domain via the server 102. A middleware server domain may be a logically related group of middleware server resources that managed as a unit. A middleware server domain may comprise the server 102 and one or more managed servers 145. The managed servers 145 may be standalone devices and/or collected devices in a server cluster. The server cluster may be a group of managed servers 145 that work together to provide scalability and higher availability for one or more services. In this regard, the services may be developed and deployed as part of at least one domain. The services may be applications accessed via one or more dedicated application programming interfaces (APIs). In other embodiments, one instance of the managed servers 145 in the middleware server domain may be configured as the server 102. The server 102 provides a central point for managing and configure the managed servers 145, any of the one or more services, and the one or more local applications.

The at least one server processor 126 may comprise one or more processors communicatively coupled to the memory 130. The server processor 126 may be any electronic circuitry, including, but not limited to, state machines, one or more central processing unit (CPU) chips, logic units, cores (e.g., a multi-core processor), field-programmable gate arrays (FPGAs), application-specific integrated circuits (ASICs), or digital signal processors (DSPs). The server processor 126 may be a programmable logic device, a microcontroller, a microprocessor, or any suitable combination of the preceding. The one or more server processors 126 may be configured to process data and may be implemented in hardware or software executed by hardware. For example, the server processor 126 may be 8-bit, 16-bit, 32-bit, 64-bit or of any other suitable architecture. The server processor 126 may include an arithmetic logic unit (ALU) for performing arithmetic and logic operations, processor registers that supply operands to the ALU and store the results of ALU operations, and a control unit that fetches the instructions 132 from the memory 130 and executes them by directing the coordinated operations of the ALU, registers and other components. In this regard, the one or more server processors 126 are configured to execute various instructions. For example, the one or more server processors 126 are configured to execute the instructions 132 to implement the functions disclosed herein, such as some or all of those described with respect to FIGS. 1-3C. In some embodiments, the functions described herein are implemented using logic units, FPGAs, ASICs, DSPs, or any other suitable hardware or electronic circuitry.

In one or more embodiments, the server peripherals 124 may be any suitable hardware and/or software to facilitate any suitable type of wireless and/or wired connection. These connections may include, but not be limited to, all or a portion of network connections coupled to the Internet, an Intranet, a private network, a public network, a peer-to-peer network, the public switched telephone network, a cellular network, a local area network (LAN), a metropolitan area network (MAN), a wide area network (WAN), and a satellite network. The server peripherals 124 may be configured to support any suitable type of communication protocol as would be appreciated by one of ordinary skill in the art.

The memory 130 may be volatile or non-volatile and may comprise a read-only memory (ROM), random-access memory (RAM), ternary content-addressable memory (TCAM), dynamic random-access memory (DRAM), and static random-access memory (SRAM). The memory 130 may be implemented using one or more disks, tape drives, solid-state drives, and/or the like. The memory 130 is operable to store the instructions 132, the one or more performances 134, at least one usage availability 136, the one or more provisioning operations 103, the one or more provisioning parameters 138, the network information 140 comprising the server resources 141, the one or more server donors 142, the one or more differences 143, and the one or more server recipients 144, the one or more provisioned servers 146, the one or more communication operations 148, the one or more AI commands 150, the one or more AI algorithms 152 configured to train and/or perform one or more operations in accordance with the one or more models 154, the one or more rules and policies 156, the one or more setting configurations 158 associated with management and/or control of the one or more resources 141 in the one or more of the data centers 108, the historical data 159 associated with one or more managed servers 145, the one or more sub-system operations 162 comprising HVAC operations 164, the one or more power supply operations 165, the one or more automation operations 166, the one or more security operations 168, and the one or more server farm operations 169, the one or more expected usages 170, the one or more tokens 181 comprising the one or more tokens 181 comprising representation of historical usage 182 and one or more electronic credits 183 for one or more managed servers 145, one or more conditional parameters 184 associated with one or more the differences 143, the one or more tracking parameters 185 and the one or more one or more thresholds 186, and/or any other data or instructions. The instructions 132 may comprise any suitable set of instructions, logic, rules, or code operable to execute the server processor 126.

The performances 134 may be one or more previous performances 134 and/or one or more expected performances 134 associated with the one or more managed severs 145. The previous performances 134 may be one or more previously tracked performance aspects of a given managed server 145. The previous performances 134 may be collected periodically or dynamically over time. The previous performances 134 may represent performance aspects of the managed servers 145 after the servers are reprovisioned. The previous performances 134 may be obtained after using one or more tracking parameters 185 to control, regulate, and/or monitor different performance aspects of the managed servers 145. The performance aspects may be one or more processor performance aspects, one or more memory performance aspects, and/or one or more communication aspects. The expected performances 134 may be one or more expected performance aspects of a given managed server 145. The expected performances 134 may be calculated periodically or dynamically over time. The expected performances 134 may be estimates on future performance aspects of the managed servers 146 if the servers are not reprovisioned. The expected performances 134 may be calculated after using one or more tracking parameters 185 to control, regulate, and/or monitor different performance aspects of the managed servers 145. The performance aspects may be one or more processor performance aspects, one or more memory performance aspects, and/or one or more communication aspects.

In one or more embodiments, the usage availability 136 may reference one or more processing capabilities of one or more of the managed servers 145 and/or data centers 108. The usage availability 136 may be one or more traffic processing availabilities configured to reference whether one or more managed servers 145 and/or one or more data centers 108 are capable of handling one or more additional operations over a period of time. In some embodiments, the usage availabilities 136 may represent one or more unused resources 141 in a given managed server 145 and/or a data center 108 within a period of time.

The one or more provisioning parameters 138 may be one or more indicators configured to provide information associated with one or more operations of entities accessing the network 110. The one or more provisioning parameters 138 may be stored in one or more formats. The one or more provisioning parameters 138 may be configured to generate one or more access commands based on the performances 134, setting configurations 158, and the expected usages 170. In this regard, the access commands may be information indicating modifications and/or assignments of resources 141 in the network 110. The access commands may be replaced, updated, and/or modified dynamically. The access commands may comprise results of one or more operations of the processing engine configured to perform one or more of the provisioning operations 103, which may comprise one or more modification operations and one or more orchestration operations, the communication operations 148, and/or the sub-system operations 162. The access commands may be one or more triggers configured to enable access between individual managed servers 145 and/or the data centers 108 determined to perform one or more communication operations 148.

The one or more provisioning parameters 138 may be configured to instruct and/or trigger provisioning aspects of one or more manages servers 145 and/or one or more data centers 108. The provisioning aspects may comprise one or more provisioning plans, layouts, and/or equipment arrangements for one or more managed servers 145 and/or data centers 108 in one or more geographical locations 113. The one or more provisioning parameters 138 may comprise one or more deployment parameters configured to instruct and/or trigger deployment aspects of one or more managed servers 145 and/or one or more data centers 108. The deployment aspects may comprise dates, times, and/or configurations for one or more managed servers 145 and/or data centers 108 in one or more geographical locations 113.

The one or more provisioning parameters 138 may comprise one or more routing commands configured to guide routing of one or more data elements, pieces of information data, and/or configuration commands within the network 110. The routing commands may be configured to start, control, organize, and/or stop one or more communication operations 148 exchanged with one or more managed servers 145 and/or one or more of the data centers 108. The routing commands may be configured to divide one or more bandwidth traffic from one portion of a communication spectrum to another and/or divide the communication spectrum in multiple portions.

The provisioning operations 103 may be one or more operations in which the provisioning parameters 138 are used to provision operations and/or regulate performance of one or more managed servers 145 and/or one or more data centers 108. In some embodiments, the provisioning operations 103 and/or the one or more communication operations 148 may be executed by the server processor 126 configured to enable data objects comprising one or more data elements to be exchanged between the server 102, the data centers 108, and/or one or more additional devices communicatively coupled to the server 102 based on the one or more rules and policies 156. In one or more embodiments, the provisioning operations 103 and/or the one or more communication operations 148 may be configured to indicate one or more data objects (e.g., via data object information) to be exchanged between the server 102 and/or at least one of the data centers 108. The data exchange operations 104 may be configured to generate and analyze one or more requests and/or one or more reports. The reports may comprise data indicating warnings and alerts among other information. In some embodiments, the reports may be audio and/or visual signaling presented in the one or more server peripherals 124. The one or more requests may be one or more communications configured to provide triggers in the form of communication or control signals to start operations such as fetching the instructions 132 or running one or more of data exchange operations. The requests may provide user information to the server 102 to indicate at least one data center profile associated with one or more of entitlements to access and/or modify any of services available in the server 102. The requests may be configured to provide lists, security information, and configuration commands that the server 102 uses to set up a specific service for one of the data centers 108. The requests may comprise data that provides starting procedure configuration to the server 102. In one or more embodiments, the requests may be optimized (e.g., simplified to a target state of efficiency) instructions that trigger establishing of a specific procedure in the server 102.

In one or more embodiments, the requests may be one or more information strings, alphanumeric data, and/or configuration commands to be exchanged in a data network. The one or more requests may be configured to trigger one or more of the data exchange operations and/or one of the communication operations 148. The requests may be exchanged in bulk or individually over the network 110. The requests may be one or more communications configured to provide triggers in the form of communication or control signals to start operations such as fetching the instructions 132 or performing the provisioning operations 103, and/or the one or more communication operations 148. The requests may provide user information to the server 102 to indicate at least one data center profile associated with one or more of the entitlements to access and/or modify any of the services available in the server 102.

The requests may be one or more communications configured to provide triggers in the form of communication or control signals to start operations such as fetching the instructions 132 or running one or more of the provisioning operations 103 and/or the one or more communication operations 148.

In one or more embodiments, the provisioning operations 103 and/or the one or more communication operations 148 may be one or more operations performed by one or more services. The provisioning operations 103 and/or the one or more communication operations 148 may be one or more operations comprising multiple stages and/or transitions at different services. For example, one or more of the provisioning operations 103 and/or the one or more communication operations 148 may be configured to start at one service that transitions to other data centers 108. For example, the server 102 may be configured to set up one or more of the provisioning operations 103 and/or the one or more communication operations 148 and one or more data elements and/or data records to be modified by the one or more services.

The provisioning operations 103 may be one or more one or more commands and/or guidelines configured to inform allocation of resources 141 in a data center 108 and/or one or more managed servers 145 associated with specific data centers 108. The provisioning operations 103 may comprise one or more instructions to purchase, order, construct, and/or assemble equipment in a data center 108 and/or a specific portion of the data center 108. For example, the provisioning operations 103 may comprise instructions to purchase, install, and configure one or more HVAC solution in a given data centers 108.

The provisioning operations 103 may comprise one or more modification operations. The modification operations may be one or more one or more commands and/or guidelines configured to inform modification of resources 141 in a data center 108 and/or one or more servers associated with specific data centers 108. The modification operations may comprise one or more instructions to move, rearrange, and/or exchange equipment in a data center 108 and/or a specific portion of the data center 108. For example, the modification operations may comprise instructions to replace, reinstall, and/or reconfigure one or more HVAC systems 180 in a given data center 108.

The provisioning operations 103 may comprise one or more orchestration operations. The orchestration operations may be one or more one or more commands and/or guidelines configured to inform movement and/or changes of resources 141 in a data center 108 and/or one or more managed servers 145 associated with specific data centers 108. The orchestration operations may comprise one or more instructions to move, rearrange, and/or exchange equipment in a data center 108 and/or a specific portion of the data center 108. For example, the orchestration operations 105 may comprise instructions to reroute, reallocate, and/or reposition one or more configuration settings in one or more HVAC systems 180 of a given data center 108.

The one or more communication operations 148 may be one or more data exchanges performed between two or more network devices in the system 100. The network devices may comprise the server 102 and one or more of the data centers 108, among others. In one or more embodiments, the communication operations 148 may be audio communications exchanged as part of audio conversations (e.g., during a telephonic call) between two or more network devices. The communication operations 148 may be image and/or text communications exchanged as part of image-based conversations (e.g., during videocalls and/or chat exchanges) between two or more network devices.

In some embodiments, the network information 140 may comprise information associated with the managed servers 145. The network information 140 may be configuration feedback from one or more of the managed servers 145 and/or one or more control commands and/or identifiers associated with the managed servers 145.

The configuration feedback may comprise data, metadata, and one or more reports. The configuration feedback may comprise information provided by and/or obtained from the data centers 108 and/or individual managed servers 145 during one or more communication operations 148. The server 102 may be configured to perform one or more retrieving operations configured to determine data and/or metadata from the communication operations 148 and generate one or more reports associated with interactions of the data centers 108 and/or individual managed servers 145 in the network 110. The configuration feedback may be provided continuously and/or periodically over time from one or more of the data centers 108 and/or individual managed servers 145 to the server 102. The configuration feedback may be data indicating whether any of the data centers 108 and/or individual managed servers 145 are attempting to perform one or more specific data exchange operations in the network 110. The configuration feedback may be obtained via one or more of the server peripherals 124. The configuration feedback may comprise multiple data samples. Each data sample may comprise a magnitude and a duration. The configuration feedback may be configured to indicate one or more attempted actions associated with the communication operations 148. The configuration feedback may indicate one or more changes in the behavior associated with one or more of the data centers 108 and/or individual managed servers 145. In one or more embodiments, the data may be information data representative on one or more communication operations 148 performed and/or triggered by the one or more data centers 108 and/or individual managed servers 145. The metadata may be data that represents extracted information and/or summarized information associated with one or more operations attempted and/or performed by the data centers 108 and/or individual managed servers 145. In the example of FIG. 1, the data and/or metadata may be active information comprising business metadata and/or passive information comprising technical metadata. The active information may be metadata used by one of the applications and may be dynamic in nature. The passive information may be metadata collected from the applications during one or more application operations and may be static in nature. In one or more embodiments, the reports comprise one or more communications and/or transmissions configured to provide information relating to a status of one or more of the communication operations 148. The reports may comprise and/or trigger alerts to other servers and/or one or more of the data centers 108 and/or individual managed servers 145. The configuration feedback may comprise one or more usage efficiencies configured to represent one or more usage efficiencies of the resources 141. The usage efficiencies may be configured to reference and/or indicate performance of one or more aspects of performance in the data centers 108 and/or individual managed servers 145.

In one or more embodiments, the resources 141 may be one or more memory resources, processor resources, and/or power resources in a given managed server 145 and/or a given data center 108. The resources 141 may comprise one or more memory units and/or processing units allocated to complete one or more operations in the data centers 108 and/or one or more managed servers 145. The resources 141 may be one or more aspects of data centers 108 configured to perform one or more specific operations in a server and/or one or more of the sub-system operations 162 of the data center 108.

The control commands and/or identifiers may represent one or more resources 141 associated with the managed servers 145 and/or one or more roles of the managed servers 145 in the system 100. The roles may comprise donors 142 and/or recipients 144 in the managed servers 145. To determine whether a managed server 145 is a donor 142 or a recipient 144, the server 102 may be configured to evaluate the configuration feedback and determine differences between one or more usage availability 136 and/or one or more expected usages 170.

In the network information 140, the donors 142 may be multiple managed servers 145 determined to comprise a surplus in usage availability 136 when compared with a real expected usage 170 at the same managed server 145. The donors 142 may be server donors 142 determined to be capable of help balancing loads in other managed servers 145 communicatively coupled to the network 110. Further, the recipients 144 may be multiple managed servers 145 determined to comprise a deficit in usage availability 136 when compared with a real expected usage 170 at the same managed server 145. The recipients 144 may be server recipients 144 determined to not be capable of balancing its own load. The differences 143 may be values obtained from subtracting the usage availability 136 when compared with a real expected usage 170 for a given managed server 145.

The one or more provisioned servers 146 may be an indicator referencing that a given managed server 145 is provisioned for a predefined period of time and is not a server donor 142 or a server recipient 144. A provisioned server 146 may be a managed server 145 that is determined to meet the demands of a load in the manages server 145 at a given point in time.

In one or more embodiments, the AI algorithms 152 may be executed by the server processor 126 to evaluate the provisioning operations 103, the one or more performances 134, the usage availability 136, the expected usages 170, and/or the one or more communication operations 148. Further, the AI algorithms 152 may be configured to interpret and transform the requests and/or the instructions 132 into structured data sets and subsequently stored as files or tables. The AI algorithms 152 may cleanse, normalize raw data, and derive intermediate data to generate uniform data in terms of encoding, format, and data types. The AI algorithms 152 may be executed to run user queries and advanced analytical tools on the structured data and/or the unstructured data in accordance with one or more models 154. The AI algorithms 152 may be configured to generate the one or more AI commands 150 based on one or more results of the provisioning operations 103, the one or more performances 134, the usage availability 136, the expected usage 170, and/or the one or more communication operations 148. The AI commands 150 may be parameters that proactively trigger one or more of data exchange operations. The AI commands 150 may be combined with the existing instructions 132 to dynamically trigger and/or perform one or more data authentication operations and/or some or all of the data exchange operations. The AI commands 150 may be configured to trigger one or more cognitive AI operations in accordance with one or more models 154. The models 154 may be trained by the one or more AI algorithms 152 based on historic information associated with any data exchange operations 104 performed by the services and/or the server 102.

The rules and policies 156 may be security configuration commands or regulatory operations predefined by an organization or one or more users 114. In one or more embodiments, the rules and policies 156 may be dynamically defined by the one or more users 114. The rules and policies 156 may be prioritization rules configured to instruct one or more managed servers 145 to perform one or more evaluating operations or perform one or more operations in the system 100 in a specific communication operation 148. The one or more rules and policies 156 may be predetermined or dynamically assigned by a corresponding user 114 or an organization associated with the users 114.

The setting configurations 158 may be one or more configuration selections for one or more managed servers 145 and/or one or more data centers 108. The setting configurations 158 may instruct operation arrangements of one or more of the services and/or one or more configuration aspects of the managed servers 145 and/or the data centers 108 over a period of time. The setting configurations 158 may reference one or more configuration aspects of specific sub-systems in the data centers 108.

The historical data 159 maybe information associated with previous performance 134 of the managed servers 145, expected performance 134 of the managed servers 145, and expected usage availability 136 in the managed servers 145. The historical data 159 may be historic information associated with one or more data exchange operations in a communication network. The historical data 159 may comprise one or more historic indicators representing one or more trends associated with usage of tokens 181 for a specific data exchange operation, specific services, and/or specific configuration parameters. The historical data 159 may be information associated with specific data center information associated with a specific managed server 145. In some embodiments, one or more models 154 may be one or more artificial intelligence models 154 configured to evaluate tracked activity and predicted activity associated with one or more managed servers 145 against general historical data 159. The general historical data 159 may be information associated with generalized data center information that is not associated with a specific data center 108 and/or a specific managed server 145. The historical data 159 may be some of the information used to train the AI algorithms 152, one or more supervised models, and/or one or more unsupervised models.

The sub-system operations 162 may be one or more operations performed by one or more of the managed servers 145 and/or one or more of the data centers 108. The sub-system operations 162 may be one or more operations that relate to one or more sub-systems in a specific data center 108. The sub-system operations 162 may comprise one or more HVAC operations 164, one or more power supply operations 165, one or more automation operations 166, one or more security operations 168, and/or one or more server farm operations 169. The HVAC operations 164 may comprise one or more operations associated with ventilation control, regulation and/or analysis of the HVAC systems 180 in a given data center 108. The power supply operations 165 may comprise one or more operations associated with power generation, distribution, and/or storage of the power supply systems 178 in a given data center 108. The automation operations 166 may comprise one or more operations associated with automation, data analyses, and/or training mechanisms in a given data center 108. The security operations 168 may comprise one or more operations associated with safety, encryption/decryption, and/or control of sensitive information exchanged with a given data center 108. The server farm operations 169 may comprise one or more operations associated with server operations, decentralized data analyses performed in the decentralized networks 106, and/or centralized communications associated with one or more managed servers 145 in a given data center 108.

In one or more embodiments, the expected usages 170 may be expected consumption of resources 141 at a given managed server 145 at a given point in time. The expected usages 170 may be values representative of one or more weighted parameters tracked for the given managed server 145.

In one or more embodiments, one or more of the managed servers 145 may request the decentralized networks 106 via the server 102 to perform one or more data exchange operations an generate the tokens 181 dynamically or periodically over time in accordance with one or more configuration parameters 190. The configuration parameters 190 may at least be partially based on the requests from the managed servers 145. The triggers received from the managed servers 145 may be referenced as part of one or more configuration parameters 190. In some embodiments, the tokens 181 may be a non-fungible token (NFT) that are generated along encrypted geolocation of the managed servers 145 and point-of-exchange (PoE) information. The PoE information may comprise location information in which a request is triggered by one of the managed servers 145. In some embodiments, the PoE information indicate a relation between a specific data exchange operation, one or more entitlements, and one or more server profiles obtained when a data exchange is attempted. The tokens 181 may be a string of numbers, alphanumeric characters, one or more words or phrases, one or more letters, and/or symbols that are minted in the decentralized networks 106 (e.g., a blockchain) in accordance with a specific protocol and/or data exchange encryption. In some embodiments, the tokens 181 are generated in accordance with one or more token attributes. The server 102 may be configured to present data exchange output receipts in one or more reports to the managed servers 145.

The one or more tokens 181 may comprise one or more authentication parameters and/or one or more communication parameters configured to verify authenticity of one or more portions of data associated with the data exchange operations. The services may be configured to generate one or more tokens. Herein, the server 102 may be configured to determine one or more verification elements and save these verification elements in the form of one or more tokens 181. In one or more embodiments, the tokens 181 may be configured to provide reference verification information to confirm whether verification information received is authentic and/or whether one or more data exchange operations transitions from another service are acceptable or not acceptable. The tokens 181 may comprise access credentials associated with one or more services expected to perform one or more of the data exchange operations 104. The one or more tokens 181 may be configured to reference whether a specific service is entitled to access network resources associated with performing one or more data exchange operations at the specific service. In some embodiments, the tokens 181 may comprise one or more data elements referencing a service precedence and/or a service destination. In some embodiments, the tokens 181 may be created, deleted, and/or modified after one or more of the services trigger a specific data exchange operation. The tokens 181 may be modified, updated, removed, and/or eliminated in accordance with one or more smart contracts.

The tokens 181 may comprise information associated with historical usage 182 and one or more electronic credits 183 associated with a given managed server 145. The historical usage may be usage and/or consumption of resources 141 at a specific managed server 145. The electronic credits 183 may be values assigned for each managed server 145 based on a number of resources 141 provided to help load balancing other managed servers 145. The electronic credits 183 may be provided in the tokens 181 to each of the managed servers 145. The electronic credits 183 may be assigned in proportion to a number of resources 141 that a given managed server 145 is expected to use to help another managed server 145. The electronic credits 183 may be assigned in proportion to a number of resources 141 that a given managed server 145 is unable to use to manage its own load.

The one or more conditional parameters 184 may be one or more indicators configured to provide information associated with one or more knowledge domains and/or operations of entities accessing the network 110. The conditional parameters 184 may be stored in one or more formats. The server processor 126 may be configured to generate the one or more conditional parameters 184 based on information collected from one or more specific managed servers 145. The conditional parameters 184 may be replaced, updated, and/or modified dynamically. The conditional parameters 184 may be replaced, updated, and/or modified periodically. The conditional parameters 184 may be one or more conditions imposed in the reception and/or transmission of electronic credits 183. The conditional parameters 184 may alter the electronic credits 183 received and/or transmitted via the tokens 181. The conditional parameters 184 may be a distance between geographical locations 113 of the managed servers 145, previous usage of the managed servers 145, and/or weather conditions at a geographical location 113 associated with one of the managed servers 145 among others.

In one or more embodiments, the server 102 may be configured to generate one or more reports. The one or more reports may comprise data indicating warnings and alerts among other information. In some embodiments, the one or more reports may be audio and/or visual signaling presented in the one or more server peripherals 124 and/or the one or more sub-systems. In one or more embodiments, the one or more reports may comprise a release roadmap to incorporate the one or more possible anomaly corrections and/or suggestions into the configuration parameters 190. In some embodiments, the one or more reports may be generated to indicate one or more instructions 132 to incorporate the one or more possible modification suggestions into the configuration parameters 190.

The tracking parameters 185 may be one or more parameters created using trained AI algorithms 152 to track performance aspects of a given managed server 145. The tracking parameters 185 may be at least partially similar among managed servers 145. For example, first tracking parameters 185 for a first managed server 145 may comprise tracking HVAC system performance for a period of time while second tracking parameters 185 for a second managed server 145 may comprise tracking HVAC system usage for the same period of time. In this example, while both sets of tracking parameters 185 relate to HVAC system operations, the first tracking parameters 185 track performance (e.g., efficiency, power consumption, and the like against a target), while the second tracking parameters 185 track usage (e.g., efficiency, power consumption, and the like as raw values). The tracking parameters 185 may be different from one managed server 145 to another. For example, first tracking parameters 185 for a first managed server 145 may comprise tracking HVAC system performance for a period of time while second tracking parameters 185 for a second managed server 145 may comprise tracking security system performance for the same period of time.

The one or more thresholds 186 may be one or more specific numbers and/or number ranges associated with a specific parameter and/or indicator. The one or more thresholds 186 may be a specific value representing a higher boundary or a lower boundary. The one or more thresholds 186 may be one or more threshold ranges comprising higher boundaries and lower boundaries. The one or more thresholds 186 may be a percentage value representing a similarity and/or a difference between one or more values assigned as tolerances for current configuration parameters 190, one or more reference data element values, and/or one or more reference data record values. The one or more thresholds 186 may be determined based on information associated with the requests. The one or more thresholds 186 may be determined dynamically over time. The one or more thresholds 186 may be predefined and/or predetermined in accordance with information in activity associated with one or more of the requests. In some embodiments, the server 102 may be configured to calculate the one or more thresholds 186 based on information obtained via the server peripherals 124 and/or sub-systems of the data centers 108. The one or more thresholds 186 may be the same for multiple managed servers 145. The one or more thresholds 186 may be unique for each of the managed servers 145.

In one or more embodiments, the databases 122 may be one or more repositories configured to store information. In one example, the server 102 may determine whether the server processor 126 is available (e.g., running) to perform a specific service. In another example, the server 102 may determine that a specific managed server 145 is running to enable a testing application and/or perform the specific service upon receiving a server response indicating that a corresponding managed server 145 is available to perform the service. The databases 122 may be configured to store one or more representations of data instead of storing coded data. In this regard, the representations may be encoded in accordance with an encoder configured to identify and/or verify exchanged information. For example, the databases 122 may comprise one or more representations of the configuration feedback. As the configuration feedback is obtained, the server processor 126 may be configured to process the configuration feedback in accordance with one or more operations triggered and/or caused upon execution of the AI algorithm 152.

### Network

The network 110 facilitates communication between and amongst the various devices of the system 100. The network 110 may be any suitable network operable to facilitate communication between the server 102 and the data centers 108 of the system 100. The network 110 may include any interconnecting system capable of transmitting audio, video, signals, data, data packets, messages, or any combination of the preceding. The network 110 may include all or a portion of a public switched telephone network (PSTN), a public or private data network, a LAN, a MAN, a WAN, a local, regional, or global communication or computer network, such as the Internet, a wireline or wireless network, an enterprise intranet, or any other suitable communication link, including combinations thereof, operable to facilitate communication between the devices.

### Dara Center

In one or more embodiments, the data centers 108 maybe one or more physical facilities that store application information (e.g., service configurations) and data associated with one or more operations performed in the communication network. The data centers 108 may be a location where computing and networking equipment is used to collect, process, and store data, as well as to distribute and enable access to processing resources, memory resources, and/or power resources. In some embodiments, the server 102 may be located in one or more of the data centers 108.

The data centers 108 may employ a combination of hardware sensors and service (e.g., software applications) to record one or more performance metrics associated with the data centers 108. In some embodiments, the hardware sensors include, but are not limited to, climate sensors, power sensors that measure power consumption, humidity sensors, differential pressure sensors that monitor airflow by measuring pressure differences between different areas of a data center 108 or data center sub-systems, and vibration sensors. The services may be configured to monitor and record performance metrics may include performance monitoring (PM) tools that are configured to monitor, measure and/or determine several performance metrics associated with the data center 108 such as CPU response time, CPU usage, memory usage, error rate, application response time, availability of an application, throughput, network latency, disk input (I)/output (O) and the like. For example, a performance monitoring tool may determine the CPU response time based on the measured CPU utilization percentage.

In one or more embodiments, each of the data centers 108 (e.g., the data center 108a in the geographical location 113a and the data center 108b in the geographical location 113b) may comprise one or more computing devices configured to communicate with other devices, such as the server 102, one or more of the sub-systems, databases, and the like in the system 100. Each of the data centers 108 may be configured to perform specific functions described herein and interact with the server 102 and/or any other data centers 108. Examples of computing devices in the data centers 108 comprise, but are not limited to, a laptop, a computer, a smartphone, a tablet, a smart device, an internet-of-things (IoT) device, a simulated reality device, an augmented reality device, or any other suitable type of device. The data centers 108 may comprise one or more interfaces and/or peripherals comprising I/O displays, voice microphones, or sensors capturing gestures performed by a corresponding user 114.

The data centers 108 may comprise hardware configured to create, transmit, and/or receive information. The data centers 108 may be configured as a provider node or as worker nodes in the network 110. The data centers 108 may be configured to receive inputs from a user 114, process the inputs, and generate data information or command information in response. The data information may include informational messages, error messages, and/or documents or files generated using a graphical user interface (GUI). The informational messages and the error messages may be generated based on recorded values of one or more performance metrics and may include the recorded values of the one or more performance metrics and other information such as alerts and recommendations.

The data centers 108 may employ systems that generate and/or are used to generate performance indicators indicating performance of various hardware and/or software components associated with a given data center 108. Each performance indicator may include, but is not limited to, informational messages, error messages, recorded values of performance metrics, or a combination thereof. An informational message in a data center 108 may be a notification that provides details about a previous status and/or current status of a system and/or device within the given data center 108, indicating and/or referencing normal operations, non-critical events, and/or updates without any immediate action required. In some embodiments, an informational message is a message conveying non-urgent information about one or more conditions and/or functionality at the data center 108. An error message in a data center 108 may be a notification that alerts operators (e.g., users 114) to a problem and/or solvable event occurring within the data center infrastructure, such as a server malfunction, network connectivity loss, storage failure, and/or power supply issue, signaling that something is not functioning as expected and needs attention.

In one or more embodiments, the one or more interfaces may be any suitable hardware or software (e.g., executed by hardware) configured to facilitate any suitable type of communication in wireless or wired connections. These connections may comprise, but not be limited to, all or a portion of network connections coupled to additional data centers 108, the server 102, the Internet, an Intranet, a private network, a public network, a peer-to-peer network, the public switched telephone network, a cellular network, a LAN, a MAN, a WAN, and a satellite network. The interfaces may be configured to support any suitable type of communication protocol. In one or more embodiments, the one or more peripherals may comprise audio devices (e.g., speaker, microphones, and the like), input devices (e.g., keyboard, mouse, and the like), or any suitable electronic component that may provide a modifying or triggering input to the data centers 108. For example, the one or more peripherals may be speakers configured to release audio signals (e.g., voice signals or commands) during media playback operations. In another example, the one or more peripherals may be microphones configured to capture audio signals. In one or more embodiments, the one or more peripherals may be configured to operate continuously, at predetermined time periods or intervals, or on-demand.

The one or more processors may be communicatively coupled to and in signal communication with the one or more interfaces, the one or more peripherals, and the one or more memories. The one or more processors may be any electronic circuitry, including, but not limited to, state machines, one or more CPU chips, logic units, cores (e.g., a multi-core processor), FPGAs, ASICs, or DSPs. The one or more processors may be programmable logic devices, microcontrollers, microprocessors, or any suitable combination of the preceding. The one or more processors may be configured to process data and may be implemented in hardware or software executed by hardware. For example, the one or more processors may be 8-bit, 16-bit, 32-bit, 64-bit, or any other suitable architecture. The one or more processors may comprise an ALU to perform arithmetic and logic operations, processor registers that supply operands to the ALU, and store the results of ALU operations, and a control unit that fetches software instructions such as data center instructions from the memory and executes the instructions by directing the coordinated operations of the ALU, registers, and other components via a processing engine. The one or more processors may be configured to execute various instructions.

The memory may comprise multiple operation data and one or more local applications (e.g., server) associated with the server 102. The operation data may be data configured to enable one or more data processing operations such as those described in relation with the server 102. The operation data may be partially or completely different from those comprised in the memory 130. The local applications may be one or more of the services described in relation with the server 102. In some embodiments, the local applications may be partially or completely different from those comprised in the memory 130.

Referring as a non-limiting example to the data center 108a of FIG. 1, the data center 108a may be hardware and/or software, executed by hardware, that manages, controls, and/or monitors the resources 141 and/or data stored in the data center 108a. Although not explicitly shown in FIG. 1, the data center 108a may include one or more processors, one or more memories, and one or more transceivers configured to generate one or more communication signals. In one or more embodiments, the data center 108a is a device, a system, and/or a combination of systems and/or devices in a predetermined geographical location 113a in which the server 102, one or more of the managed servers 145, and/or one or more user devices are located. In some embodiments, radio waves, electromagnetic (EM) signaling, and/or communication operations 148 from the data center 108a are monitored over time in the network 110 to be evaluated in combination with the one or more provisioning operations 103, among others.

In one or more embodiments, a performance metric associated with a given data center 108 may comprise measurable units that indicate performance of a data center equipment (or component therein) or a software application. The performance metrics may be monitored and measured in a data center 108 including, but not limited to, ventilation levels associated with a data center equipment (e.g., server farms 172) or a component therein (e.g., CPU), power consumption of a data center equipment, humidity, airflow, vibrations, CPU response time, CPU usage, memory usage, error rate, application response time, availability of an application, throughput, network latency, and disk I/O. CPU response time is a measure of the time taken by a CPU to respond to a request. CPU usage is a percentage of processing power utilized by software applications running at one or more server farms 172 that may highlight potential performance bottlenecks. The memory usage is an amount of memory (e.g., random access memory (RAM)) consumed at the one or more server farms 172. The error rate may be a percentage of requests that result in error, signifying application stability and potential anomalies. The application response time may indicate a time taken by a software application to respond to a request indicating how quickly the application reacts to interactions. The availability of an application may be a percentage of time a software application is operational and accessible to users and systems. The throughput may be a number of requests that the server farms 172 or a software application can process per unit time (e.g., per second) indicating its capacity to manage traffic. The network latency may be a time that takes for data to travel between one or more elements in the data center equipment and/or data center sub-systems. The disk I/O may be a rate at which data is read and written to a storage device.

The one or more server farms 172 may be one or more server clusters and/or a collection of computer servers maintained and/or provisioned dynamically and/or periodically over time. The server farms 172 may comprise large numbers of servers comprising several (e.g., hundreds, thousands, and/or hundreds of thousands) computing systems and/or devices. The server farms 172 may comprise one or more servers configured to perform one or more specific operations in accordance with one or more specific services. The server farms 172 may be comprise one or more backup units configured to provide redundancies and/or support to one or more operations and/or services in a given data center 108. The server farms 172 may comprise one or more core processing units that run various services and sometimes store data. The server farms 172 may be deployed at a data center 108 to comprise several types of storage devices and systems such as traditional hard drives (HDDs), solid-state drives (SSDs), and specialized systems like Storage Area Networks (SANs) or Network-Attached Storage (NAS). The server farms 172 may comprise servers configured with and/or comprising networking equipment comprising switches and routers that facilitate internal communication between data center equipment (e.g., between servers) as well as external communication between the data center 108 and devices/systems external to the data center 108 (e.g., other data centers 108). As shown in the example of FIG. 1, a data center 108 may comprise at least one server farm 172 comprising multiple server racks that house several types of data center equipment. For example, a server rack may include servers, networking equipment (e.g., switches and/or routers), storage solutions, power distribution units (PDUs) that distribute electrical power to equipment within a server rack, cables that connect different devices within the rack and other part of the data center 108, patch panels used to organize and manage network cables, cable management system that assist in keeping cables organized and prevent clutter, or combinations thereof.

In one or more embodiments, services and/or software applications that are hosted and/or run in the data center 108 (e.g., by servers in the server farms 172) may include, but are not limited to, operating systems, virtualization software, management and orchestration software, security systems 174, performance monitoring tools, backup and recovery software, database management systems (DBMS), or a combination thereof.

The one or more security systems 174 may be configured to protect one or more components of a data center 108 from unauthorized access, theft, and/or corruption. The one or more security systems 174 may comprise network security configured to use firewalls, intrusion detection systems, and other security measures to protect the network 110 that connects the data center 108. The one or more security systems 174 may comprise intrusion detections configured to use intrusion detection systems (IDS) to identify unauthorized access to the data center 108 and alert security personnel. The one or more security systems 174 may comprise one or more firewalls configured to use security systems to monitor and control incoming and outgoing network traffic. The one or more security systems 174 may be comprise data encryption configured to use data encryption to ensure information that is unreadable to unauthorized users. The one or more security systems 174 may comprise access controls configured to enable services 161 in one or more servers, allow access based on authorization commands, and use strong safety controls. The one or more security systems 174 may comprise data center security encompassing practices and preparation configured to keep a given data center 108 secure from threats, attacks, and unauthorized access.

The one or more automation systems 176 may be hardware and/or software executed by hardware configured to manage and/or execute routine data center operations like provisioning servers, monitoring performance, managing storage, network configuration, and disaster recovery without manual intervention, optimizing efficiency and reducing human error. The one or more automation systems 176 may comprise one or more routine workflows and processes of a data center 108 comprising scheduling, monitoring, maintenance, application delivery, and the like.

The one or more power supply systems 178 may be configured to receive, process, and/or distribute power in the data center 108. The one or more power supply systems 178 may comprise one or more uninterruptible power supplies (UPSs), one or more power distribution units (PDUs), and one or more remote power panels (RPPs). The UPSs may comprise battery backups to cover a time between a detection of utility issues and a generator starting. The PDUs may comprise individual equipment racks that are served by PDUs offering both metered and unmetered options. With metered PDUs, the data center 108 may obtain more analytics associated with power consumption. The RPPs may comprise connectors between the PDUs and the individual devices. The one or more power supply systems 178 may be configured to retrieve data from a power generator, an electrical grid, and/or an alternative power source prior to distribution in the data center 108. The one or more power supply systems 178 may be configured to provide electrical power to various data center equipment and components thereof in a data center 108 such as servers, networking equipment, storage solutions, and HVAC solutions.

The one or more HVAC systems 180 may be configured to regulate and/or control humidity and/or airflow within the data center 108, ensuring proper functioning of sensitive computer servers by maintaining a consistent cool environment and filtering out dust particles that could damage equipment. The one or more HVAC systems 180 may comprise one or more solutions configured to prevent overheating of servers and other hardware within the data center 108. The one or more HVAC systems 180 may comprise chillers and cooling towers configured to cool water that circulates through the data center 108, absorb heat from the air, and/or dissipate heat into the atmosphere, ensuring the water remains at an optimal warmth and/or cool level. The one or more HVAC systems 180 may comprise one or more air distribution systems configured to ensure that cooled air is evenly distributed throughout the data center 108, maintaining uniform conditions across all server racks. The one or more HVAC systems 180 may be configured to maintain optimal climate conditions for the data center equipment and may include air conditioning systems, liquid cooling systems, and/or other systems employing advanced cooling technologies to avoid and/or prevent overheating of data center equipment (e.g., servers).

### Decentralized Network

In one or more embodiments, the decentralized networks 106 comprises a peer-to-peer networking protocol that enables development of serverless applications. The decentralized networks 106 may include multiple electronic components or devices (i.e., nodes 112) comprising specific node data. The nodes 112 may not be required to store or validate all data in the decentralized network 106. Instead, validation of each node's data may be obtained via peer accountability. The decentralized networks 106 may be a blockchain network configured to perform one or more decentralized operations.

In some embodiments, the nodes 112 may include only their own data and a reference to all other data in a given decentralized network 106 in accordance with rules and/or policies preestablished by an electronic component or device outside the given decentralized network 106 (e.g., one or more servers, such as the server 102). Each node may comprise one or more configuration parameters 190 and/or one or more data exchange controls 192. The configuration parameters 190 may determine how the nodes 112 interact with each other and the server 102. The configuration parameters 190 may be updated dynamically or periodically with additional data received as updates via one or more planning components (e.g., electronic devices or components configured to provide updates to the configuration parameters 190). The updates may be triggered by a perceived lack of knowledge level in the nodes 112. A perceived knowledge level in the nodes 112 may be identified via node scores (not shown) received from the server 102 as feedback.

In one or more embodiments, each node (i.e., out of nodes 112) in the given decentralized network 106 includes knowledge-specific information and information associated with peer accountability and a perceived knowledge level. Specifically, referencing the node 112a as a non-limiting example, includes configuration parameters 190a and data exchange controls 192a. The data exchange controls 192a may include information corresponding to at least one knowledge domain configured to perform interactions of one or more managed servers 145. In one or more embodiments, the node 112a may be configured to receive one or more of initial tokens. Upon receiving the tokens 181, the node 112a may be configured to determine whether any of entitlements of the initial tokens correspond to the knowledge information included in the data exchange controls 192a.

In other embodiments, the node 112a includes a processor (not shown) configured to provide updates corresponding to specific updated data exchange controls 192a. The processor in the node 112a may be configured to provide updated tokens directly to the server processor 126. Further, the processor of the node 112a may be configured to route any initial tokens that are not updated to one of the other nodes 112 in accordance with one or more configuration parameters 190 governing the given decentralized network 106. The data exchange controls 192 at a given node 112 may be configured to generate a token 181 representative of a request, historical usage 182, and the electronic credits 183, and perform a corresponding interaction in one or more of the decentralized networks 106. In some embodiments, the data exchange controls 192 may enable the token 181 to perform interactions between a first decentralized network 106 and a second decentralized network 106. Each of the decentralized networks 106 may comprise corresponding configuration information configured to interpret the requests in the given token 181.

In the example of FIG. 1, a representation of the decentralized networks 106 includes five nodes 112a-112e. However, additional nodes or fewer nodes may be included. In some embodiments, each of the nodes 112 includes corresponding configuration parameters 190 and corresponding data exchange controls 192. In the decentralized networks 106 of FIG. 1, the node 112a includes the configuration parameters 190a and the updated data exchange controls 192a; the node 112b includes the configuration parameters 190b and the updated data exchange controls 192b; the node 112c includes the configuration parameters 190c and the updated data exchange controls 192c; the node 112d includes the configuration parameters 190d and the updated data exchange controls 192d; and the node 112e includes the configuration parameters 190e and the updated data exchange controls 192e.

### Operational Flow to Dynamically Reprovision Artificial Intelligence-Controlled Servers Via Decentralized Networks

FIG. 2 shows an operational flow 200 in which the system 100 of FIG. 1 is configured to provision, reprovision, deploy, and/or redeploy data centers 108 and/or individual servers in the data centers 108, in accordance with one or more embodiments. The operational flow 200 may be performed between the server 102 acting as a resource controller 202 and one or more entities. The entities may comprise managed servers 145 such as the provisioned servers 146, the server donors 142, and/or the server recipients 144, user devices, network components, and/or the data centers 108 among others. In FIG. 2, the operational flow 200 comprises multiple operations 220-230. The operational flow 200 shows one or more operations 220 in relation to the decentralized networks 106, one or more operations 222 in relation to the resource controller 202, one or more operations 224 in relation to the server recipients 144, one or more operations 226 in relation to the server donors 142, and one or more operations 230 in relation to the provisioned servers 146. As described in relation to the system 100 of FIG. 1, the managed servers 145 may be one or more servers at least partially collocated in a same geographical location 113. Further, the managed servers 145 may be one or more servers at least partially disturbed over multiple geographical locations 113.

In one or more embodiments, the resource controller 202 may be configured to regulate communication between the provisioned servers 146, server donors 142, server recipients 144 and the decentralized networks 106. In some embodiments, the resource controller 202 may be configured to trigger modifications, creation, and/or deletion of tokens 181. The decentralized networks 106 may comprise one or more decentralized ledgers 240 tracking one or more electronic credits 183, one or more tokens 181, one or more historical usage 182, and/or one or more assignments 244. The decentralized ledgers 240 may be distributed over several nodes 112 in the decentralized networks 106. The decentralized ledgers 240 may be configured to maintain updated information relating the electronic credits 183 as part of one or more assignments 244 when one or more tokens 181 are created.

In one or more embodiments, the resource controller 202 may be configured to invoke the AI commands 150 and/or the AI algorithms 152 to evaluate one or more communication operations 148 from an entity attempting to access network resources 141 in the system 100. The server 102 may be configured to provide one or more data elements as outputs to artificial intelligence operations (e.g., machine learning operations). The resource controller 202 may be configured to perform one or more classical layer operations. The classical layer operations may be one or more operations configured to provide access between one or more data centers 108 and one or more services (e.g., applications). The services may be configured to provide access to one or more network resources in the network 110 via the server 102 and/or one or more managed servers 145 located in one or more data centers 108. The one or more managed servers 145 may be one or more of the servers in the server farms 172. The one or more data elements may be individual data in one or more data objects. The data elements may be alphanumeric bitstrings comprising a specific format. The data elements may be data information configured to reference data objects stored in a specific database. The data elements may comprise configuration feedback, one or more setting configurations 158, and/or one or more usage availabilities 136 associated with the one or more managed servers 145 and/or one or more of the data centers 108. The one or more responses may comprise one or more provisioning parameters 138.

The artificial intelligence operations may comprise one or more operations performed by the server processor 126. The artificial intelligence operations may comprise the one or more models 154. The artificial intelligence operations may comprise one or more operations using one or more supervised models, one or more unsupervised models, one or more neural networks, and/or one or more LLM operations. The artificial intelligence operations may comprise dynamic analysis of the resources 141 associated to one or more of the data managed servers 145 in the data centers 108, the provisioning parameters 138, the usage availability 136, and the expected usages 170. The supervised models may be one or more models 154 configured to evaluate tracked activity and predicted activity associated with one or more managed servers 145 and/or data centers 108 against specific historical data 159. The specific historical data 159 may be information associated with specific data center information associated with a specific managed server 145. The unsupervised models may be one or more models 154 configured to evaluate tracked activity and predicted activity associated with one or more managed servers 145 against general historical data 159. The general historical data 159 may be information associated with generalized data center information that is not associated with a specific data center profile. The evaluation data may be one or more processed versions of the data elements received from the classical layer operations. The evaluation data may be one or more of the configuration feedback. The evaluation data may be some of the information used to train the AI algorithms 152, the supervised models, and/or the unsupervised models.

In some embodiments, the actions and/or operations of the data centers 108 may be evaluated, diagnosed, controlled, and/or managed by the system upon execution of one or more AI algorithms 152 in accordance with one or more models 154. The models 154 may be supervised models and/or unsupervised models, among others. The supervised models may be models 154 trained to understand and/or predict operations associated with a specific user profile in the communication network. The unsupervised models may be models 154 trained to understand and/or predict operations associated with general behavior of entities interacting with the communication network. The models 154 may be implemented in accordance with one or more guidelines, to perform network analyses using one or more neural networks, and/or one or more LLMs. The neural networks may be a computing system comprising a network of interconnected nodes, called artificial neurons, to process data in a decentralized manner. The neural networks may be trained through empirical adverse impact minimization. The neural networks may be configured to optimize operations of a system (e.g., one of the data centers), an apparatus (e.g., one of the servers), and/or additional communication components. Herein, optimization may refer to an iterative approach to evaluate information with the intent of causing one or more performance results that meet one or more dynamic and/or static target performance parameters. The neural networks may be configured to minimize a difference, or empirical adverse impacts, between a predicted output and actual target values in a given dataset. The LLMs may be AI models that use machine learning to process and generate human language. The LLMs may be trained on large amounts of data to learn statistical relationships and perform natural language processing (NLP) tasks. The LLMs may be used to generate and translate information, summarize content, determine one or more intents based on the content, recognize content associated with a completion of the intent, and predict additional content to complete the intent. The artificial intelligence operations may be configured to generate one or more triggers to initiate one or more training operations.

The resource controller 202 may be configured to perform one or more training generation operations. The training generation operations may comprise one or more operations performed by the server processor 126. The training generation operations may be one or more training operations configured to generate training data. The system alerts may be one or more error messages, informational messages, and/or reports. The data center data may be one or more data and/or metadata elements configured to form one or more of the configuration feedback and/or the setting configurations 158, among others. The training controls may be one or more instructions configured to guide and/or control usage of training data. The differences 143 may be one or more differentials between a number of available resources 141 and a number of predicted resources 141 to be used in a given managed server 145 and/or data center 108. A reprovisioning window may be one or more configuration windows in which the server 102 determines to perform one or more updates to the managed servers 145 and/or the data centers 108. The target performances 134 may be one or more optimized performances associated with one or more parameters in one or more managed servers 145 and/or one or more of the data centers 108. The data center information may be one or more directories associating one or more managed servers 145 and/or one or more data centers 108 with one or more entitlements in the system 100. In some embodiments, the entitlements may indicate access commands for the managed servers 145 and/or the data centers 108 that may be specific to a geographical location 113 and/or a set of operations in the network 110. The data center information may comprise one or more data center profiles configured to catalog one or more aspects of a given managed server 145 and/or a data center 108 for reference by the training generation operations. The data center profiles may be configured to compile information associated with one or more architectural and/or configuration aspects of a given managed server 145 and/or a data center 108. The resources 141 available at a given data center 108 may be considered as one or more elements during one or more of the training generation operations. The historical data 159 may be historic information associated a given managed server 145 and/or a data center 108 in a communication network. The historical data 159 may comprise one or more historic indicators representing one or more trend values (e.g., trends) associated with usage of resources 141 in a specific geographical location 113, a specific data center 108, and/or specific services 161.

The operations 220 may comprise one or more communication inputs and/or outputs from the decentralized networks 106. The operations 222 may comprise transmission and/or reception of data, controls, and/or additional information to/from the resource controller 202. The operations 224-230 may be operations comprising communication operations 148 performed by one or more of the managed servers 145 in which network resources 141 are assigned between server donors 142 and server recipients 144. The assignments 244 may be one or more operations in which specific usage of resources 141 at a given managed server 145 are reserved for usage in a particular process and/or a particular service (e.g., application).

In conventional systems, system administrators have challenges while trying to maintain server usage in an optimal state of resources, especially managing various user sessions on these servers effectively is often a challenge. The issue takes an even more acute form when a footprint of a server base is big, and they are a mixed bag of new, old, and archaic servers with different kinds of available resources 141. In some cases, even newer servers with may into issues due to a load on the CPUs or an available memory. In conventional systems, a systems administrator has a few tools to deal with such issues, but these are mostly reactive in nature and often boil down to delayed solutions such as ending sessions in a given server to free up resources 141. Further, there are servers that sit idle for long periods of time. These servers may be often underutilized. As a result, these servers remain idle as the application hosted on them may have a reduced traffic profile. Such problems do not have any easy solutions and often result in non-linear and sub-optimal investment in infrastructure.

In one or more embodiments, the resource controller 202 may be configured to use the decentralized networks 106 to crate a confederation of resources 141 in a pool that provide a flexible arrangement, where the nodes 112 may join or leave at any time without damaging the resource allocation process or each server's autonomy. The resource controller 202 may be configured to use the electronic credits 183 to generate one or more assignments 244 associated with one or more contributing managed servers 145 to earn and/or lose electronic credits 183 based on preferences, premium processing slots, extended slots, parallel slots, and the like.

In some embodiments, the resource controller 202 may be configured to implement an AI-based system configured to watch over a global pool, transactions getting triggered, loading across geographies, and the like. The resource controller 202 may be configured to quickly detect and stop anomalous transactions (e.g., saturation attacks) even if triggered from different geographies. A web of deployed resource monitors on the managed servers 145 may act as a feeder service to a central system but may select and raise local events for critical system review.

In one or more embodiments, the managed servers 145 may exit or enter the network 110 at any time. In some embodiments, the managed servers 145 may exit or enter the network 110 with prior approval of the resource controller 202. The resource controller 202 may be configured to trigger creation of the tokens 181 to provide any managed servers 145 entering the network 110 with a base number of electronic credits 183. The electronic credits 183 may be representative of an ability of each managed server 145 to manage traffic loads from other managed servers 145. The electronic credits 183 may be associated with specific managed servers 145 such that individual managed servers 145 may be configured to comprise a value corresponding to electronic credits 183. In one or more embodiments, the resource controller 202 may be configured to execute trained artificial intelligence algorithms to analyze resources and assign resources 141 among managed servers 145. In some embodiments, the decentralized ledgers 240 may be configured to maintain information associated with a hostname, IP addresses, running processers, and system information for each managed server 145.

In one or more embodiments, the server donors 142 may be configured to send ownership requests for certain data exchange operations using a key generation center (KGC) to the server recipients 144, which generates unique keys using trapdoor cryptography. The server donors 142 and the server recipients 144 may be configured to allow change of ownership for certain data exchange operations and confirmation of the ownership using the generated keys.

In one or more embodiments, the server donors 142 may be configured to provide ownership one or more data exchange operations to the server recipients 144 as part of the reprovisioning of resources 141.

### Example Process to Dynamically Reprovision Artificial Intelligence-Controlled Servers Via Decentralized Networks

FIGS. 3A and 3C illustrates an example flowchart of a process 300 configured to provision resources in servers located in data centers, in accordance with one or more embodiments. Modifications, additions, or omissions may be made to the process 300. The process 300 may comprise more, fewer, or other operations than those shown in FIGS. 3A-3C. For example, operations may be performed in parallel or in any suitable order. While at times discussed as the server 102, the data centers 108, or components of any of thereof performing operations described in operations 302-392 in the process 300, any suitable system or components of the system 100 may perform one or more operations of the process 300. For example, one or more operations of the process 300 may be implemented, at least in part, in the form of instructions 132 of FIG. 1, stored on non-transitory, tangible, machine-readable media (e.g., a non-transitory computer-readable medium such as memory 130 of FIG. 1) that when run by one or more processors (e.g., the classical processor 128 of FIG. 1) may cause the one or more processors to perform operations described in operations 302-392.

The process 300 starts at operation 302, where the server 102 is configured to electronically calculate a number of servers (e.g., managed servers 145 in one or more of the server farms 172) available for dynamic provisioning in a network 110 (e.g., in connection with the network 110). The servers may be one or more managed servers 145 communicatively coupled to the network 110. At operation 310, the server 102 is configured to determine whether there is more than one server available for dynamically provisioning in the network 110. The server 102 may be configured to request a number of acknowledgement responses and/or feedback from any managed servers 145 connected to the network 110. The server 102 may be configured to receive, in response to the requests, communication commands from the managed servers 145. If the server 102 determines that the number of managed servers 145 is less than one (e.g., NO), the process 300 proceeds to operation 312. At operation 312, the server 102 is configured to electronically pause until one or more additional server broadcasts that the additional server is available for dynamic provisioning in the network. Herein, the server 102 may be configured to wait for communications broadcasted from one or more additional managed servers 145 joining (e.g., connecting to) the network 110. If the server 102 determines that the number of managed servers 145 is greater than one (e.g., YES), the process 300 proceeds to operation 314. At operation 312, the server 102 is configured to select a first server and a second server for dynamic provisioning. The first server and the second server may be at least two of the servers connected to the network 110.

In some embodiments, the first server may be the server 102 and the second server may be one managed server. Herein, a total number of servers connected to the network 110 may always be equal to one because the server 102 is connected to the network 110. In other embodiments, the total number of servers connected to the network 110 may be equal to zero if the server 102 is not considered as part of the network information 140.

At operation 316, the server 102 is configured to train an artificial intelligence algorithm 152 based on input data representative of historical data 159 associated with previous performance 134 of the first server and the second server, expected performance 134 of the first server and the second server, and expected usage availability 136 in the first server and the second server. The process 300 continues at operation 320 and operation 350.

At operation 320, the server 102 is configured to provision first server in accordance with provisioning parameters 138. The server 102 is configured to provision the first server in the network 110. At operation 322, the server 102 is configured to create tracking parameters 185 configured to track a first performance 134 of the first server. The server 102 may be configured to create, using the trained artificial intelligence algorithm 152, first tracking parameters 185 configured to track the first performance 134 of the first server. At operation 324, the server 102 is configured to track the first performance 134 of the first server. The second tracking parameters 185 may be specifically created for the second server. The server 102 may be configured to track, in conjunction with the first tracking parameters 185, the first performance 134 of the first server. At operation 326, the server 102 is configured to electronically assign the first performance 134 of the first server to a first real expected usage 170 in the first server. The server 102 may be configured to electronically assign, using the trained artificial intelligence algorithm 152, the first performance 134 of the first server to the first real expected usage 170 in the first server. At operation 328, the server 102 is configured to determine whether the first real expected usage 170 of the first server is above an expected usage threshold 186. The server 102 may be configured to determine, using the trained artificial intelligence algorithm 152, whether the first real expected usage 170 of the first server is above the expected usage threshold 186.

At operation 330, the server 102 is configured to determine whether the real expected usage 170 is above the usage threshold 186. If the server 102 determines that the real expected usage 170 is not above the usage threshold 186 (e.g., NO), the process 300 proceeds to operation 342. At operation 342, the server 102 is configured to tag the first server as a provisioned server 146. In response to determining that the first real expected usage 170 of the first server is above the expected usage threshold 186, tag the first server as a provisioned server 146. At operation 344, the server 102 is configured to electronically pause for a predefined time duration. The predefined duration may be a timer, a predefined time duration, and/or one or more periods of time. At this stage, the process 300 proceeds to operation 302. At operation 302, the server 102 may be configured to determine one or more managed servers connected to the network 110 that are available for provisioning. At this stage, the first server may not be considered as part of the servers available for provisioned given that the first server is determined in operation 342 to be a provisioned server 146. If the server 102 determines that the first real expected usage 170 is above the usage threshold 186 (e.g., YES), the process 300 proceeds to operation 332. At operation 332, the server 102 is configured to tag the first server as a recipient server (e.g., one of the recipients 144). In response to determining that the first real expected usage 170 of the first server is above the expected usage threshold 186, the server 102 may be configured to tag the first server as a recipient server. At operation 334, the server 102 is configured to calculate a recipient difference 143 between the first real expected usage 170 of the first server and the expected usage threshold 186. The server 102 may be configured to calculate, using the trained artificial intelligence algorithm 152, the recipient difference 143 between the first real expected usage 170 of the first server and the expected usage threshold 186. Then, the process 300 proceeds to operation 376.

At operation 350, the server 102 is configured to provision second server in accordance with provisioning parameters 138. The server 102 is configured to provision the second server in the network 110. At operation 352, the server 102 is configured to create tracking parameters 185 configured to track a second performance 134 of the second server. The server 102 may be configured to create, using the trained artificial intelligence algorithm 152, second tracking parameters 185 configured to track the second performance 134 of the second server. The second tracking parameters 185 may be specifically created for the second server. In this regard, the first tracking parameters 185 may be different from the second tracking parameters 185. At operation 354, the server 102 is configured to track the second performance 134 of the second server. The server 102 may be configured to track, in conjunction with the second tracking parameters 185, the second performance 134 of the second server. At operation 356, the server 102 is configured to electronically assign the second performance 134 of the second server to a second real expected usage 170 in the second server. The server 102 may be configured to electronically assign, using the trained artificial intelligence algorithm 152, the second performance 134 of the second server to the second real expected usage 170 in the second server. At operation 358, the server 102 is configured to determine whether the second real expected usage 170 of the second server is above the expected usage threshold 186. The server 102 may be configured to determine, using the trained artificial intelligence algorithm 152, whether the second real expected usage 170 of the second server is below the expected usage threshold 186.

At operation 360, the server 102 is configured to determine whether the second real expected usage 170 is above the usage threshold 186. If the server 102 determines that the real expected usage 170 is not above the usage threshold 186 (e.g., NO), the process 300 proceeds to operation 362. At operation 362, the server 102 is configured to tag the second server as a provisioned server 146. In response to determining that the first real expected usage 170 of the first server is above the expected usage threshold 186, tag the first server as a provisioned server 146. At operation 364, the server 102 is configured to electronically pause for a predefined time duration. The predefined duration may be a timer, a predefined time duration, and/or one or more periods of time. At this stage, the process 300 proceeds to operation 302. At operation 302, the server 102 may be configured to determine one or more managed servers connected to the network 110 that are available for provisioning. At this stage, the first server may not be considered as part of the servers available for provisioned given that the first server is determined in operation 342 to be a provisioned server 146. If the server 102 determines that the real expected usage 170 is above a usage threshold 186 (e.g., YES), the process 300 proceeds to operation 372. At operation 372, the server 102 is configured to tag the second server as a donor server. In response to determining that the second real expected usage 170 of the second server is below the expected usage threshold 186, the server 102 may be configured to tag the second server as a donor server (e.g., one of the donors 142). At operation 374, the server 102 is configured to calculate a donor difference 143 between the second real expected usage 170 of the second server and the expected usage threshold 186. The server 102 may be configured to calculate, using the trained artificial intelligence algorithm 152, a donor difference 143 between the second real expected usage 170 of the second server and the expected usage threshold 186. At operation 376, the server 102 is configured to compare the recipient difference 143 to the donor difference 143. The server 102 may be configured to compare, using the artificial intelligence algorithm 152, the recipient difference 143 to the donor difference 143.

At operation 380, the server 102 is configured to compare the recipient difference 143 and the donor difference 143. If the server 102 determines that the recipient difference 143 is greater than the donor difference 143 (e.g., YES), the process 300 proceeds to operation 382. The recipient difference 143 and the donor difference 143 may be one or more numerical values comprising similar formats (e.g., text format). At operation 382, the server 102 is configured to reprovision the first server in accordance with the provisioning parameters 138 to handle the first real expected usage 170 of the first server minus the recipient difference 143. Herein, in response to the recipient difference 143 being greater than the donor difference 143, the server 102 may be configured to reprovision the first server in the network 110 in accordance with the provisioning parameters 138 to handle the first real expected usage 170 of the first server minus the recipient difference 143. If the server 102 determines that the recipient difference 143 is not greater than the donor difference 143 (e.g., NO), the process 300 proceeds to operation 392. The recipient difference 143 and the donor difference 143 may be one or more numerical values comprising similar formats (e.g., text format). At operation 392, the server 102 is configured to reprovision the second server in accordance with the provisioning parameters 138 to handle the second real expected usage 170 of the second server plus the recipient difference 143. Herein, in response to the recipient difference 143 being less than the donor difference 143, the server 102 may be configured to reprovision the second server in the network 110 in accordance with the provisioning parameters 138 to handle the second real expected usage 170 of the second server plus the recipient difference 143.

The process 300 may end at operation 382 and operation 392, where the servers are reprovisioned in accordance with updated provisioning parameters 138. After reprovisioning, the servers may be configured to perform one or more communication operations 148 and/or one or more sub-system operations 162 in accordance with the updated provisioning at the first server and the second server.

In some embodiments, the server 102 may be configured to reprovision additional servers in the network 110 in accordance with the updated provisioning parameters 138. The additional servers may be configured to load balance one or more portions of real expected usages 170 in the additional servers, a portion of the first real expected usage in the first server, and a second real expected usage of the second server.

In one or more embodiments, the server 102 may be configured to, in conjunction with tagging the first server as the recipient server, electronically assign first electronic credits 183 with the first server. The first electronic credits 183 may be configured to represent a first historical usage 182 of network resources 141 in the first server. Further, in conjunction with tagging the second server as the donor server, the server 102 may be configured to electronically assign second electronic credits 183 with the second server. The second electronic credits 183 may be configured to represent a second historical usage 182 of network resources 141 in the second server.

In some embodiments, the server 102 may be configured to determine, using the trained artificial intelligence algorithm 152, one or more conditional parameters 184 associated with the donor difference 143. The conditional parameters 184 may be representative of a depletion of network resources 141 in the second server after reprovisioning the second server in the network 110 in accordance with the provisioning parameters 138 to handle the second real expected usage 170 of the second server plus the recipient difference 143. In response to determining the conditional parameters 184 associated with the donor difference 143, the server 102 may be configured to calculate an exchange credit amount based at least in part upon the conditional parameters 184. The first electronic credits 183 are configured to lose a number of electronic credits equal to the exchange credit number; and the second electronic credits 183 may be configured to gain the number of electronic credits equal to the exchange credit amount. In response to reprovisioning the first server in the network 110 in accordance with the provisioning parameters 138 to handle the first real expected usage 170 of the first server minus the recipient difference 143, the server 102 may be configured to subtract the number of electronic credits from the first electronic credits 183. In response to reprovisioning the second server in the network 110 in accordance with the provisioning parameters 138 to handle the second real expected usage 170 of the second server plus the recipient difference 143, the server 102 may be configured to add the number of electronic credits to the second electronic credits 183. Further, the server 102 may be configured to associate an updated version of the first electronic credits 183 with the first server and associate an updated version of the second electronic credits 183 with the second server.

In one or more embodiments, the conditional parameters 184 may be representative of a depletion of network resources 141 in the second server after reprovisioning the second server in the network 110 in accordance with the provisioning parameters 138 to handle the second real expected usage 170 of the second server plus the recipient difference 143 and a distance between a first geographical location 113 comprising the first server and a second geographical location 113 comprising the second server. The conditional parameters 184 may be representative of: the depletion of network resources 141 in the second server after reprovisioning the second server in the network 110 in accordance with the provisioning parameters 138 to handle the second real expected usage 170 of the second server plus the recipient difference 143 and a time of day in which the second server is reprovisioned. In some embodiments, the conditional parameters 184 may be representative of: the depletion of network resources 141 in the second server after reprovisioning the second server in the network 110 in accordance with the provisioning parameters 138 to handle the second real expected usage 170 of the second server plus the recipient difference 143 and whether the second server previously assisted in balancing a traffic load from the first server. The first electronic credits 183 and the second electronic credits 183 may be modified and tracked in multiple ledgers distributed in the nodes 112 comprised in corresponding decentralized networks 106. The decentralized networks 106 may be a federated blockchain network.

### Scope of the Disclosure

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
a memory operable to store:
at least one artificial intelligence algorithm configured to evaluate data; and
at least one processor communicatively coupled to the memory and configured to:
provision a first server in a network in accordance with a plurality of provisioning parameters;
provision a second server in the network in accordance with the plurality of provisioning parameters;
train an artificial intelligence algorithm based at least in part upon input data representative of historical data associated with previous performance of the first server and the second server, expected performance of the first server and the second server, and expected usage availability in the first server and the second server;
create, using the trained artificial intelligence algorithm, a first plurality of tracking parameters configured to track a first performance of the first server;
track, in conjunction with the first plurality of tracking parameters, the first performance of the first server;
electronically assign, using the trained artificial intelligence algorithm, the first performance of the first server to a first real expected usage in the first server;
determine, using the trained artificial intelligence algorithm, whether the first real expected usage of the first server is above an expected usage threshold;
in response to determining that the first real expected usage of the first server is above the expected usage threshold, tag the first server as a recipient server;
calculate, using the trained artificial intelligence algorithm, a recipient difference between the first real expected usage of the first server and the expected usage threshold;
create, using the trained artificial intelligence algorithm, a second plurality of tracking parameters configured to track a second performance of the second server;
track, in conjunction with the second plurality of tracking parameters, the second performance of the second server;
electronically assign, using the trained artificial intelligence algorithm, the second performance of the second server to a second real expected usage in the second server;
determine, using the trained artificial intelligence algorithm, whether the second real expected usage of the second server is below the expected usage threshold;
in response to determining that the second real expected usage of the second server is below the expected usage threshold, tag the second server as a donor server;
calculate, using the artificial intelligence algorithm, a donor difference between the second real expected usage of the second server and the expected usage threshold;
compare, using the artificial intelligence algorithm, the recipient difference to the donor difference;
in response to the recipient difference being greater than the donor difference, reprovision the first server in the network in accordance with the plurality of provisioning parameters to handle the first real expected usage of the first server minus the recipient difference; and
in response to the recipient difference being less than the donor difference, reprovision the second server in the network in accordance with the plurality of provisioning parameters to handle the second real expected usage of the second server plus the recipient difference.

2. The system of claim 1, wherein the processor is further configured to:
provision a third server in the network in accordance with the plurality of provisioning parameters;
provision a fourth server in the network in accordance with the plurality of provisioning parameters;
create, using the trained artificial intelligence algorithm, a third plurality of tracking parameters configured to track a third performance of the third server;
track, in conjunction with the third plurality of tracking parameters, the third performance of the third server;
electronically assign, using the artificial intelligence algorithm, the third performance of the third server to a third real expected usage in the third server;
determine, using the artificial intelligence algorithm, whether the third real expected usage of the third server is below the expected usage threshold;
in response to determining that the third real expected usage of the third server is below the expected usage threshold, reprovision the third server in the network in accordance with the plurality of provisioning parameters to handle the third real expected usage of the third server;
create, using the trained artificial intelligence algorithm, a fourth plurality of tracking parameters configured to track a fourth performance of the fourth server;
track, in conjunction with the fourth plurality of tracking parameters, the fourth performance of the fourth server;
electronically assign, using the train artificial intelligence algorithm, the fourth performance of the fourth server to a fourth real expected usage in the fourth server;
determine, using the trained artificial intelligence algorithm, whether the fourth real expected usage of the fourth server is below the expected usage threshold; and
in response to determining that the fourth real expected usage of the fourth server is below the expected usage threshold, reprovision the fourth server in the network in accordance with the plurality of provisioning parameters to handle the fourth real expected usage of the fourth server.

3. The system of claim 1, wherein the processor is further configured to:
in conjunction with tagging the first server as the recipient server, electronically assign a first plurality of electronic credits with the first server, the first plurality of electronic credits being configured to represent a first historical usage of network resources in the first server;
in conjunction with tagging the second server as the donor server, electronically assign a second plurality of electronic credits with the second server, the second plurality of electronic credits being configured to represent a second historical usage of network resources in the second server;
determine, using the trained artificial intelligence algorithm, a plurality of conditional parameters associated with the donor difference, the plurality of conditional parameters being representative of a depletion of network resources in the second server after reprovisioning the second server in the network in accordance with the plurality of provisioning parameters to handle the second real expected usage of the second server plus the recipient difference;
in response to determining the plurality of conditional parameters associated with the donor difference, calculate an exchange credit amount based at least in part upon the plurality of conditional parameters, wherein:
the first plurality of electronic credits is configured to lose a number of electronic credits equal to the exchange credit number; and
the second plurality of electronic credits is configured to gain the number of electronic credits equal to the exchange credit amount;
in response to reprovisioning the first server in the network in accordance with the plurality of provisioning parameters to handle the first real expected usage of the first server minus the recipient difference, subtract the number of electronic credits from the first plurality of electronic credits;
in response to reprovisioning the second server in the network in accordance with the plurality of provisioning parameters to handle the second real expected usage of the second server plus the recipient difference, add the number of electronic credits to the second plurality of electronic credits;
associate an updated version of the first plurality of electronic credits with the first server; and
associate an updated version of the second plurality of electronic credits with the second server.

4. The system of claim 3, wherein the plurality of conditional parameters is representative of:
the depletion of network resources in the second server after reprovisioning the second server in the network in accordance with the plurality of provisioning parameters to handle the second real expected usage of the second server plus the recipient difference; and
a distance between a first geographical location comprising the first server and a second geographical location comprising the second server.

5. The system of claim 3, wherein the plurality of conditional parameters is representative of:
the depletion of network resources in the second server after reprovisioning the second server in the network in accordance with the plurality of provisioning parameters to handle the second real expected usage of the second server plus the recipient difference; and
a time of day in which the second server is reprovisioned.

6. The system of claim 3, wherein the plurality of conditional parameters is representative of:
the depletion of network resources in the second server after reprovisioning the second server in the network in accordance with the plurality of provisioning parameters to handle the second real expected usage of the second server plus the recipient difference; and
whether the second server previously assisted in balancing a traffic load from the first server.

7. The system of claim 3, wherein:
the first plurality of electronic credits and the second plurality of electronic credits are modified and tracked in a plurality of ledgers distributed in a plurality of nodes comprised in a decentralized network.

8. The system of claim 7, wherein:
the decentralized network is a federated blockchain network.

9. A method, comprising:
provisioning a first server in a network in accordance with a plurality of provisioning parameters;
provisioning a second server in a network in accordance with the plurality of provisioning parameters;
training an artificial intelligence algorithm based at least in part upon input data representative of historical data associated with previous performance of the first server and the second server, expected performance of the first server and the second server, and expected usage availability in the first server and the second server;
creating, using the trained artificial intelligence algorithm, a first plurality of tracking parameters configured to track a first performance of the first server;
tracking, in conjunction with the first plurality of tracking parameters, the first performance of the first server;
electronically assigning, using the trained artificial intelligence algorithm, the first performance of the first server to a first real expected usage in the first server;
determining, using the trained artificial intelligence algorithm, whether the first real expected usage of the first server is above an expected usage threshold;
in response to determining that the first real expected usage of the first server is above the expected usage threshold, tagging the first server as a recipient server;
calculating, using the trained artificial intelligence algorithm, a recipient difference between the first real expected usage of the first server and the expected usage threshold;
creating, using the trained artificial intelligence algorithm, a second plurality of tracking parameters configured to track a second performance of the second server;
tracking, in conjunction with the second plurality of tracking parameters, the second performance of the second server;
electronically assigning, using the trained artificial intelligence algorithm, the second performance of the second server to a second real expected usage in the second server;
determining, using the trained artificial intelligence algorithm, whether the second real expected usage of the second server is below the expected usage threshold;
in response to determining that the second real expected usage of the second server is below the expected usage threshold, tagging the second server as a donor server;
calculating, using the artificial intelligence algorithm, a donor difference between the second real expected usage of the second server and the expected usage threshold;
comparing, using the artificial intelligence algorithm, the recipient difference to the donor difference;
in response to the recipient difference being greater than the donor difference, reprovisioning the first server in the network in accordance with the plurality of provisioning parameters to handle the first real expected usage of the first server minus the recipient difference; and
in response to the recipient difference being less than the donor difference, reprovisioning the second server in the network in accordance with the plurality of provisioning parameters to handle the second real expected usage of the second server plus the recipient difference.

10. The method of claim 9, further comprising:
provisioning a third server in the network in accordance with the plurality of provisioning parameters;
provisioning a fourth server in the network in accordance with the plurality of provisioning parameters;
creating, using the trained artificial intelligence algorithm, a third plurality of tracking parameters configured to track a third performance of the third server;
tracking, in conjunction with the third plurality of tracking parameters, the third performance of the third server;
electronically assigning, using the artificial intelligence algorithm, the third performance of the third server to a third real expected usage in the third server;
determining, using the artificial intelligence algorithm, whether the third real expected usage of the third server is below the expected usage threshold;
in response to determining that the third real expected usage of the third server is below the expected usage threshold, reprovisioning the third server in the network in accordance with the plurality of provisioning parameters to handle the third real expected usage of the third server;
creating, using the trained artificial intelligence algorithm, a fourth plurality of tracking parameters configured to track a fourth performance of the fourth server;
tracking, in conjunction with the fourth plurality of tracking parameters, the fourth performance of the fourth server;
electronically assigning, using the train artificial intelligence algorithm, the fourth performance of the fourth server to a fourth real expected usage in the fourth server;
determining, using the trained artificial intelligence algorithm, whether the fourth real expected usage of the fourth server is below the expected usage threshold; and
in response to determining that the fourth real expected usage of the fourth server is below the expected usage threshold, reprovisioning the fourth server in the network in accordance with the plurality of provisioning parameters to handle the fourth real expected usage of the fourth server.

11. The method of claim 9, further comprising:
in conjunction with tagging the first server as the recipient server, electronically assigning a first plurality of electronic credits with the first server, the first plurality of electronic credits being configured to represent a first historical usage of network resources in the first server;
in conjunction with tagging the second server as the donor server, electronically assigning a second plurality of electronic credits with the second server, the second plurality of electronic credits being configured to represent a second historical usage of network resources in the second server;
determining, using the trained artificial intelligence algorithm, a plurality of conditional parameters associated with the donor difference, the plurality of conditional parameters being representative of a depletion of network resources in the second server after reprovisioning the second server in the network in accordance with the plurality of provisioning parameters to handle the second real expected usage of the second server plus the recipient difference;
in response to determining the plurality of conditional parameters associated with the donor difference, calculating an exchange credit amount based at least in part upon the plurality of conditional parameters, wherein:
the first plurality of electronic credits is configured to lose a number of electronic credits equal to the exchange credit number; and
the second plurality of electronic credits is configured to gain the number of electronic credits equal to the exchange credit amount;
in response to reprovisioning the first server in the network in accordance with the plurality of provisioning parameters to handle the first real expected usage of the first server minus the recipient difference, subtracting the number of electronic credits from the first plurality of electronic credits;
in response to reprovisioning the second server in the network in accordance with the plurality of provisioning parameters to handle the second real expected usage of the second server plus the recipient difference, adding the number of electronic credits to the second plurality of electronic credits;
associating an updated version of the first plurality of electronic credits with the first server; and
associating an updated version of the second plurality of electronic credits with the second server.

12. The method of claim 11, wherein the plurality of conditional parameters is representative of:
the depletion of network resources in the second server after reprovisioning the second server in the network in accordance with the plurality of provisioning parameters to handle the second real expected usage of the second server plus the recipient difference; and
a distance between a first geographical location comprising the first server and a second geographical location comprising the second server.

13. The method of claim 11, wherein the plurality of conditional parameters is representative of:
the depletion of network resources in the second server after reprovisioning the second server in the network in accordance with the plurality of provisioning parameters to handle the second real expected usage of the second server plus the recipient difference; and
a time of day in which the second server is reprovisioned.

14. The method of claim 11, wherein the plurality of conditional parameters is representative of:
the depletion of network resources in the second server after reprovisioning the second server in the network in accordance with the plurality of provisioning parameters to handle the second real expected usage of the second server plus the recipient difference; and
whether the second server previously assisted in balancing a traffic load from the first server.

15. A non-transitory computer-readable medium storing instructions that when executed by a processor cause the processor to:
provision a first server in a network in accordance with a plurality of provisioning parameters;
provision a second server in the network in accordance with the plurality of provisioning parameters;
train an artificial intelligence algorithm based at least in part upon input data representative of historical data associated with previous performance of the first server and the second server, expected performance of the first server and the second server, and expected usage availability in the first server and the second server;
create, using the trained artificial intelligence algorithm, a first plurality of tracking parameters configured to track a first performance of the first server;
track, in conjunction with the first plurality of tracking parameters, the first performance of the first server;
electronically assign, using the trained artificial intelligence algorithm, the first performance of the first server to a first real expected usage in the first server;
determine, using the trained artificial intelligence algorithm, whether the first real expected usage of the first server is above an expected usage threshold;
in response to determining that the first real expected usage of the first server is above the expected usage threshold, tag the first server as a recipient server;
calculate, using the trained artificial intelligence algorithm, a recipient difference between the first real expected usage of the first server and the expected usage threshold;
create, using the trained artificial intelligence algorithm, a second plurality of tracking parameters configured to track a second performance of the second server;
track, in conjunction with the second plurality of tracking parameters, the second performance of the second server;
electronically assign, using the trained artificial intelligence algorithm, the second performance of the second server to a second real expected usage in the second server;
determine, using the trained artificial intelligence algorithm, whether the second real expected usage of the second server is below the expected usage threshold;
in response to determining that the second real expected usage of the second server is below the expected usage threshold, tag the second server as a donor server;
calculate, using the artificial intelligence algorithm, a donor difference between the second real expected usage of the second server and the expected usage threshold;
compare, using the artificial intelligence algorithm, the recipient difference to the donor difference;
in response to the recipient difference being greater than the donor difference, reprovision the first server in the network in accordance with the plurality of provisioning parameters to handle the first real expected usage of the first server minus the recipient difference; and
in response to the recipient difference being less than the donor difference, reprovision the second server in the network in accordance with the plurality of provisioning parameters to handle the second real expected usage of the second server plus the recipient difference.

16. The non-transitory computer-readable medium of claim 15, wherein, when executed by the processor, the instructions further cause the processor to:
provision a third server in the network in accordance with the plurality of provisioning parameters;
provision a fourth server in the network in accordance with the plurality of provisioning parameters;
create, using the trained artificial intelligence algorithm, a third plurality of tracking parameters configured to track a third performance of the third server;
track, in conjunction with the third plurality of tracking parameters, the third performance of the third server;
electronically assign, using the artificial intelligence algorithm, the third performance of the third server to a third real expected usage in the third server;
determine, using the artificial intelligence algorithm, whether the third real expected usage of the third server is below the expected usage threshold;
in response to determining that the third real expected usage of the third server is below the expected usage threshold, reprovision the third server in the network in accordance with the plurality of provisioning parameters to handle the third real expected usage of the third server;
create, using the trained artificial intelligence algorithm, a fourth plurality of tracking parameters configured to track a fourth performance of the fourth server;
track, in conjunction with the fourth plurality of tracking parameters, the fourth performance of the fourth server;
electronically assign, using the train artificial intelligence algorithm, the fourth performance of the fourth server to a fourth real expected usage in the fourth server;
determine, using the trained artificial intelligence algorithm, whether the fourth real expected usage of the fourth server is below the expected usage threshold; and
in response to determining that the fourth real expected usage of the fourth server is below the expected usage threshold, reprovision the fourth server in the network in accordance with the plurality of provisioning parameters to handle the fourth real expected usage of the fourth server.

17. The non-transitory computer-readable medium of claim 15, wherein, when executed by the processor, the instructions further cause the processor to:
in conjunction with tagging the first server as the recipient server, electronically assign a first plurality of electronic credits with the first server, the first plurality of electronic credits being configured to represent a first historical usage of network resources in the first server;
in conjunction with tagging the second server as the donor server, electronically assign a second plurality of electronic credits with the second server, the second plurality of electronic credits being configured to represent a second historical usage of network resources in the second server;
determine, using the trained artificial intelligence algorithm, a plurality of conditional parameters associated with the donor difference, the plurality of conditional parameters being representative of a depletion of network resources in the second server after reprovisioning the second server in the network in accordance with the plurality of provisioning parameters to handle the second real expected usage of the second server plus the recipient difference;
in response to determining the plurality of conditional parameters associated with the donor difference, calculate an exchange credit amount based at least in part upon the plurality of conditional parameters, wherein:
the first plurality of electronic credits is configured to lose a number of electronic credits equal to the exchange credit number; and
the second plurality of electronic credits is configured to gain the number of electronic credits equal to the exchange credit amount;
in response to reprovisioning the first server in the network in accordance with the plurality of provisioning parameters to handle the first real expected usage of the first server minus the recipient difference, subtract the number of electronic credits from the first plurality of electronic credits;
in response to reprovisioning the second server in the network in accordance with the plurality of provisioning parameters to handle the second real expected usage of the second server plus the recipient difference, add the number of electronic credits to the second plurality of electronic credits;
associate an updated version of the first plurality of electronic credits with the first server; and
associate an updated version of the second plurality of electronic credits with the second server.

18. The non-transitory computer-readable medium of claim 17, wherein the plurality of conditional parameters is representative of:
the depletion of network resources in the second server after reprovisioning the second server in the network in accordance with the plurality of provisioning parameters to handle the second real expected usage of the second server plus the recipient difference; and
a distance between a first geographical location comprising the first server and a second geographical location comprising the second server.

19. The non-transitory computer-readable medium of claim 17, wherein, when executed by the processor, the instructions further cause the processor to:
the depletion of network resources in the second server after reprovisioning the second server in the network in accordance with the plurality of provisioning parameters to handle the second real expected usage of the second server plus the recipient difference; and
a time of day in which the second server is reprovisioned.

20. The non-transitory computer-readable medium of claim 17, wherein the plurality of conditional parameters is representative of:
the depletion of network resources in the second server after reprovisioning the second server in the network in accordance with the plurality of provisioning parameters to handle the second real expected usage of the second server plus the recipient difference; and
whether the second server previously assisted in balancing a traffic load from the first server.
